(19) United States
(12) Patent Application Publication
(10) Pub. No.: US 2015/0012830 A1
(43) Pub. Date: Jan. 8, 2015

(54) METHOD AND APPARATUS FOR INTERWORKING APPLICATIONS IN USER DEVICE

(71) Applicant: SAMSUNG ELECTRONICS CO., LTD., GYEONGGI-DO (KR)

(72) Inventors: Wonsuk CHOI, Seoul (KR); Bokun CHOI, Seoul (KR)

(21) Appl. No.: 14/322,388

(22) Filed: Jul. 2, 2014

(30) Foreign Application Priority Data
Jul. 3, 2013 (KR) 10-2013-0078085

(51) Int. Cl. G06F 3/0481; G06F 3/0488; G06F 3/0484; H04L 29/08; G06F 3/01

(52) U.S. Cl. CPC G06F 3/0481; H04L 67/10; G06F 3/017; G06F 3/04842; G06F 3/0488
USPC 715/733; 715/765

(57) ABSTRACT

A method and apparatus for interworking applications in a user device are provided. In the method, the user device displays a plurality of applications, analyzes an attribute of each application in response to a user input for interworking the applications, and interworks the applications on the basis of the attribute of each application.

### PRIORITY

This application claims priority under 35 U.S.C. §119(a) to a Korean Patent Application filed on Jul. 3, 2013 in the Korean Intellectual Property Office and assigned Serial No. 10-2013-0078085, the entire disclosure of which is incorporated herein by reference.

### BACKGROUND

1. Field of the Invention

The present invention generally relates to a technique to interwork applications in a user device, and more particularly, to a method and apparatus for operating two or more applications interworked with each other in a user device.

2. Description of the Related Art

With the remarkable growth of digital technologies, a great variety of user devices, such as a mobile communication device, a PDA (Personal Digital Assistant), an electronic organizer, a smart phone, and a tablet PC (Personal Computer), which allow communication and personal data processing even in mobile environments, have become increasingly popular. Such user devices have outgrown their respective traditional fields, and have reached a convergence stage. For example, user devices may offer many helpful functions including a voice/video call function, a message transmission/reception function such as SMS (Short Message Service), MMS (Multimedia Message Service) or email, a navigation function, a digital camera function, a broadcast receiving/playing function, a media (including video and music) playback function, an Internet access function, a messenger function, and an SNS (Social Networking Service) function.

Additionally, portable devices having a large-sized display unit have increased in use today. In the past, a user device was limited in use due to restrictions on a screen size and an efficient input unit. However, these days, such restrictions have been reduced considerably through the increase of a screen size and the introduction of a touch screen. Meanwhile, a user device such as a tablet PC offers a multi-screen function to allow a simultaneous use of two applications or more. This function may allow a single user device to simultaneously perform two or more independent tasks and also to greatly promote task efficiency even when a single task is performed.

Namely, a multi-screen function in a user device refers to a function to individually execute respective applications through several divided screens on a single display unit. When two applications are executed using such a multi-screen function in a user device, the applications operate independently with limited interaction between them. For example, merely a function to copy a screen capture and paste it on a memo note is available as an application interworking function for a currently used user device. However, in view of a growing tendency for a multi-screen function to expand in use together with an increased use of a large-sized display unit, there is a need for various functions to enhance a convenient use of a user device based on a multi-screen.

### SUMMARY

The present invention has been made to address the above problems and disadvantages and to provide at least the advantages described below. Accordingly, an aspect of the present invention provides a method and apparatus for simply interworking different applications in a user device that supports a multi-screen environment.

Another aspect of the present invention provides a user device which may include, but is not limited to, various types of electronic devices that support a particular function and also employ an AP (Application Processor), a GPU (Graphic Processing Unit), and a CPU (Central Processing Unit).

Another aspect of the present invention provides a method and apparatus for interworking two or more applications executed simultaneously through a multi-screen in a user device and thereby performing an associated task between them.

Another aspect of the present invention provides a method and apparatus for interworking applications on the basis of an attribute defined in each application that runs in a multi-screen environment.

Another aspect of the present invention provides a method and apparatus for interworking, on a platform layer, applications executed simultaneously through a multi-screen in a user device.

Another aspect of the present invention provides a method and apparatus for allowing a user to set the priorities of attributes predefined in respective applications in a user device.

Another aspect of the present invention provides a method and apparatus for interworking different types of applications according to priorities based on a user's setting.

Another aspect of the present invention provides a method and apparatus for interworking respective applications executed in user devices and thereby performing an associated task between them.

Another aspect of the present invention provides a method and apparatus for realizing an optimum environment for supporting an interworking function of applications in a user device and thereby enhancing the convenience and usability of a user device.

According to an aspect of the present invention, a method for interworking applications in a user device is provided. This method includes displaying a plurality of applications; analyzing an attribute of each application in response to a user input for interworking the applications; and interworking the applications on the basis of the attribute of each application.

According to another aspect of the present invention, an application interworking method is provided. The method includes detecting an interworking event for an interworking between applications; distinguishing a first application and a second application from the applications; determining an attribute of the first application and an attribute of the second application; checking a priority of a specific attribute which is correlatable between the first and second applications, from among the attributes of the first and second applications; interworking the first and second applications on the basis of the priority of the specific attribute; and outputting a result of the interworking.

According to another aspect of the present invention, a user device is provided that includes a touch screen configured to display an execution screen of each of applications and to receive an interworking event for an interworking between the applications; and a control unit configured to control the applications to be interworked with each other on the basis of an attribute defined in each application.

According to another aspect of the present invention, a computer-readable medium is provided having recorded thereon a program configured to define control commands for displaying an object of an application, for detecting a user input for interworking the applications, for interworking the applications on the basis of a selected attribute of the applications, and for displaying an object caused by the interworking of the applications.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a user device in accordance with an embodiment of the present invention;

FIG. 2 is a screenshot illustrating a multi-screen of a user device in accordance with an embodiment of the present invention;

FIG. 3 is a table illustrating examples of interworking applications according to attributes defined in a user device in accordance with an embodiment of the present invention;

FIG. 4 is a flowchart illustrating a method for interworking applications in a user device in accordance with an embodiment of the present invention;

FIG. 5 is a flowchart illustrating a detailed process of interworking applications in a user device in accordance with an embodiment of the present invention;

FIGS. 6 to 12 are screenshots illustrating operating examples of interworking applications in a multi-screen of a user device in accordance with embodiments of the present invention;

FIG. 13 is a view illustrating an example of interworking an application between user devices in accordance with an embodiment of the present invention;

FIGS. 14 to 17 are flow diagrams illustrating operating examples of interworking applications between user devices in accordance with embodiments of the present invention.

### DETAILED DESCRIPTION OF EMBODIMENTS OF THE PRESENT INVENTION

The following description with reference to the accompanying drawings is provided to assist in a comprehensive understanding of various embodiments of the present invention as defined by the claims and their equivalents. It includes various specific details to assist in that understanding but these are to be regarded as mere examples. Accordingly, those of ordinary skill in the art will recognize that various changes and modifications of the embodiments described herein can be made without departing from the scope and spirit of the present invention. In addition, descriptions of well-known functions and constructions may be omitted for clarity and conciseness.

The terms and words used in the following description and claims are not limited to their dictionary meanings, but are merely used to enable a clear and consistent understanding of the present invention. Accordingly, it should be apparent to those skilled in the art that the following description of various embodiments of the present invention is provided for illustration purpose only and not for the purpose of limiting the present invention as defined by the appended claims and their equivalents.

It is to be understood that the singular forms “a,” “an,” and “the” include plural referents unless the context clearly dictates otherwise. Thus, for example, reference to “an application” includes reference to one or more of such applications.

The present invention relates to a method and apparatus for interworking applications in a user device. Particularly, this invention relates to technique to perform an interworking operation by correlating two or more applications being executed simultaneously through a multi-screen in a user device. In an embodiment of the present invention, the term “multi-screen” refers to a screen displayed on a display unit and divided into several windows, through which a plurality of applications can be executed respectively. In another embodiment, the term “multi-screen” may refer to a state or environment in which a plurality of applications can be executed through respective display units of two or more user devices.

In an embodiment of the present invention, a correlation between applications may be ascertained on the basis of an attribute defined in each application, and such applications may be interworked with each other according to a user-defined priority of attributes. In another embodiment of the present invention, a plurality of applications offered through a multi-screen may be interworked with each other on the basis of an attribute predefined in each application. In still another embodiment of the present invention, a plurality of applications executed respectively through a screen of each user device in a multi-screen environment may be interworked with each other on the basis of an attribute predefined in each application.

In an embodiment of the present invention, an attribute of each application may be defined at a platform level, and a plurality of applications executed simultaneously through a multi-screen of a single user device or a multi-screen environment of two or more user devices may be interworked with each other on the basis of such an attribute predefined in each application. Therefore, at the time of developing an application, an interworking between applications may be simply and variously defined. Further, this technique may support the development of various applications available in a multi-screen environment.

Additionally, in an embodiment of the present invention, a user may change an interworking priority about predefined priorities of each application. This may provide a user-friendly technique to interwork applications. Namely, to allow an interworking operation between two or more applications, a user can adjust priorities of attributes in different applications.

According to embodiments of the present invention, it is possible to obviate restrictions on having to use only a limited function (e.g., pasting a captured screen onto a memo note) at a limited application (e.g., a web browser, a memo note, a gallery, a message, an email, etc.). This may give enhanced convenience to developers and users of applications.

Meanwhile, although the following embodiments will be described on the assumption that a user's interworking event is a touch event based on a touch input, this is an example only and is not to be considered as a limitation of the present invention. Alternatively, an interworking event may include any other gesture such as a hovering gesture or various types of hand gestures that can be detected by various sensors.

Namely, in various embodiments of the present invention, an interworking event may include all kinds of interactions that can be entered by a user, such as a touch event, a hovering event, a hand event detectable by an infrared sensor, an illuminance sensor, a motion sensor or a camera module, and the like.

Further, in some embodiments of the present invention, a hand event may be used as a kind of an interworking event caused by a hand gesture (or a similar gesture by a hand-like object) that can be detected through a sensor (e.g., an infrared sensor, an illuminance sensor, a motion sensor or a camera module) activated in a state where an execution screen of an application is displayed.

Now, embodiments of the present invention will be fully described with reference to the accompanying drawings.

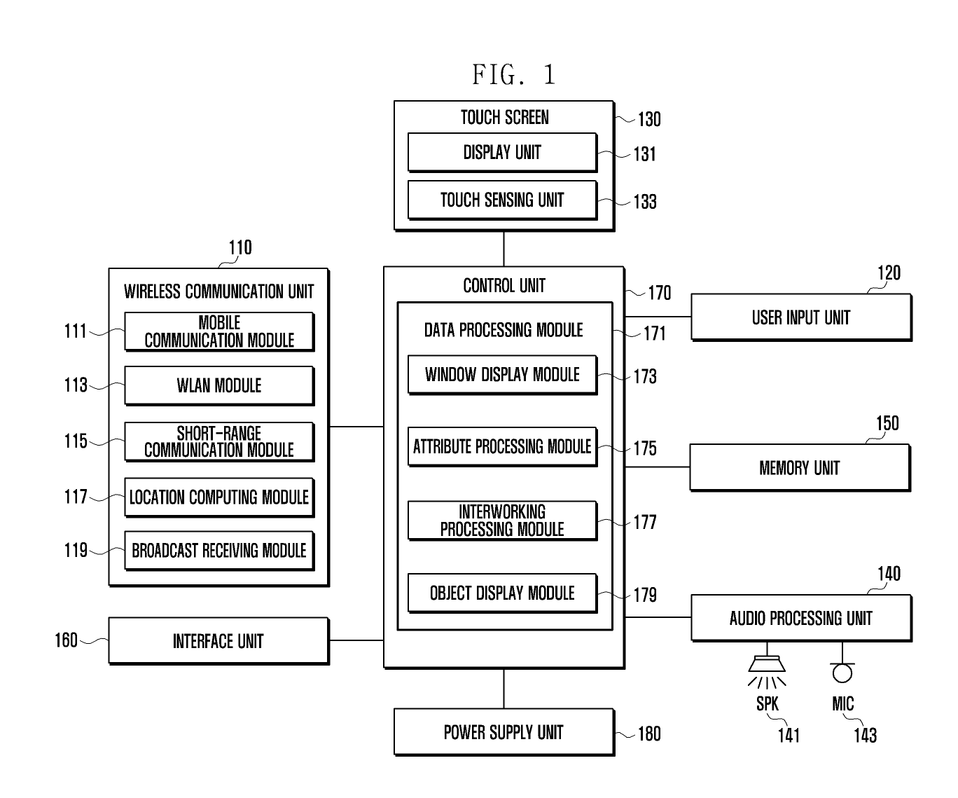

FIG. 1 is a block diagram illustrating a user device in accordance with an embodiment of the present invention.

Referring to FIG. 1, the user device includes a wireless communication unit 110, a user input unit 120, a touch screen 130, an audio processing unit 140, a memory unit 150, an interface unit 160, a control unit 170, and a power supply unit 180. These elements of the user device may be not always essential, and more or less elements may be included in the user device. For example, the user device may further include a camera module to support an image capture function. Also, the user device may remove some modules (e.g., a broadcast receiving module 119 of the wireless communication unit 110) in case the user device fails to support a broadcast receiving/playing function.

The wireless communication unit 110 may have one or more modules capable of performing a wireless communication between the user device and a wireless communication system or between the user device and any other user device. For example, the wireless communication unit 110 includes at least one of a mobile communication module 111, a WLAN (Wireless Local Area Network) module 113, a short-range communication module 115, a location computing module 117, and a broadcast receiving module 119.

The mobile communication module 111 transmits or receives a wireless signal to or from at least one of a base station, an external device, and any type of server (e.g., an integration server, a provider server, a content server, an Internet server, a cloud server, etc.) in a mobile communication network. A wireless signal may include a voice call signal, a video call signal, and text/multimedia message data. The mobile communication module 111 may perform access to various servers to download an application and/or an attribute mapped thereto under the control of the control unit 170.

The WLAN module 113 refers to a module for performing a wireless Internet access and establishing a wireless LAN link with any other user device. The WLAN module 113 may be embedded in or attached to the user device. For a wireless Internet access, well-known techniques such as Wi-Fi, Wibro (Wireless broadband), Wimax (World interoperability for microwave access), or HSDPA (High Speed Downlink Packet Access) may be used. The WLAN module 113 may perform access to various servers to download an application and/or an attribute mapped thereto under the control of the control unit 170. Also, when a wireless LAN link is formed with any other user device, the WLAN module 113 transmits or receives various data selected by a user to or from such a user device. For example, the WLAN module 113 transmits or receives predefined attribute information about each application to or from any other user device.

Particularly, the WLAN module 113 transmits or receives various data required for the interworking between one application executed in the user device and another application executed in any other user device in response to a user's input while a WLAN link is formed with any other user device. The WLAN module 113 may be always kept in a turn-on state or selectively turned on according to a user's setting or input.

The short-range communication module 115 refers to a module designed for a short-range communication. As a short-range communication technique, Bluetooth, BLE (Bluetooth Low Energy), RFID (Radio Frequency Identification), IrDA (Infrared Data Association), UWB (Ultra Wideband), ZigBee, NFC (Near Field Communication), and the like may be used. When a short-range communication is connected to any other user device, the short-range communication module 115 transmits or receives any data, selected by a user, to or from such a user device. In an embodiment of the present invention, the short-range communication module 115 transmits or receives predefined attribute information about each application to or from any other user device. The short-range communication module 115 may be always kept in a turn-on state or selectively turned on according to a user's setting or input.

The location computing module 117 refers to a module for obtaining the location of the user device, for example, a GPS (Global Positioning System) module. The location computing module 117 calculates information about time and distance from at least three base stations and then, based on such information, calculates a current location (if necessary, a three-dimensional location including latitude, longitude and altitude) through triangulation. Alternatively, the location computing module 117 may calculate a real-time location of the user device by receiving real-time data from at least three satellites. Any other technique to obtain the location of the user device may be used.

The broadcast receiving module 119 receives a broadcast signal (e.g., a TV broadcast signal, a radio broadcast signal, a data broadcast signal, etc.) and/or broadcast-related information (e.g., information about a broadcast channel, a broadcast program, a broadcast service provider, etc.) from any external broadcast management server through a broadcast channel (e.g., a satellite channel, a terrestrial channel, etc.).

The user input unit 120 receives a user's manipulation and creates input data for controlling the operation of the user device. The user input unit 120 may be selectively composed of a keypad, a dome switch, a touchpad, a jog wheel, a jog switch, various sensors (e.g., a voice recognition sensor, a proximity sensor, an illuminance sensor, an acceleration sensor, a gyro sensor, a geomagnetic sensor, a motion sensor, an image sensor, etc.), and the like. Additionally, the user input unit 120 may be formed of buttons installed at the external side of the user device, some of which may be realized in a touch panel. The user input unit 120 receives a user's input for executing and operating two or more applications on a multi-screen and then creates a corresponding input signal. Also, the user input device 120 receives a user's input for interworking two or more applications on a multi-screen and then creates a corresponding input signal.

The touch screen 130, which is an input/output unit for simultaneously performing both an input function and a display function, includes a display unit 131 and a touch sensing unit 133. Particularly, in an embodiment of the present invention, the touch screen 130 displays various screens (e.g., a full screen of a single application, a multi-screen of two or more applications, a call dialing screen, a messenger screen, a game screen, a gallery screen, and the like) associated with the operation of the user device through the display unit 131. Additionally, if any user event (e.g., a touch event or a hovering event) is detected from the touch sensing unit 133 while the display unit 131 displays a certain screen, the touch screen 130 transfers an input signal based on the detected user event to the control unit 170. Then the control unit 170 identifies the received user event and performs a particular operation in response to the user event.

The display unit 131 displays information processed in the user device. For example, when the user device is in a call mode, the display unit 131 displays a UI (User Interface) or a GUI (Graphic UI) in connection with the call mode. Similarly, when the user device is in a video call mode or a camera mode, the display unit 131 displays a received and/or captured image, UI or GUI. Particularly, the display unit 131 displays respective execution screens of two or more applications on a multi-screen and, if such applications are interworked on the multi-screen by a user, displays a specific screen of a resultantly executed function (or application). Additionally, if an execution screen of a specific application is displayed and if such an application is interworked with another application executed in any other user device by a user, the display unit 131 displays a specific screen of a resultantly executed function (or application). Also, through a popup window, the display unit 131 may display an attribute to be used for the interworking of applications in an application interworking environment. Further, depending on a rotation direction (or placed direction) of the user device, the display unit 131 may display a screen in a landscape mode or a portrait mode and, if necessary, indicate a notification of a screen switch. Example screenshots of the display unit 131 will be discussed later.

The display unit 131 may be formed of LCD (Liquid Crystal Display), TFT-LCD (Thin Film Transistor-LCD), LED (Light Emitting Diode), OLED (Organic LED), AMOLED (Active Matrix OLED), flexible display, bended display, or 3D display. Parts of such displays may be realized as a transparent display.

The touch sensing unit 133 may be placed on the display unit 131 and sense a user's touch event (e.g., a long press input event, a short press input event, a single-touch input event, a multi-touch input event, a touch-based gesture event, etc.) from the surface of the touch screen 130. When a user's touch event is sensed from the surface of the touch screen 130, the touch sensing unit 133 detects coordinates of the sensed touch event and transfers the detected coordinates to the control unit 170. Namely, the touch sensing unit 133 senses a touch event produced by a user, creates a signal associated with the sensed touch event, and transfers the created signal to the control unit 170. Then, based on the received signal, the control unit 170 performs a particular function corresponding to the detected position of the touch event.

Additionally, the touch sensing unit 133 may sense a hovering event caused by an input tool (e.g., a user's finger, an electronic pen, etc.) approaching the touch screen 130 and staying in the same altitude, create a signal associated with the sensed hovering event, and transfer the created signal to the control unit 170. In this case, even though an input tool is out of contact with the surface of the touch screen 130, the touch sensing unit 133 may sense the presence, movement, removal, or the like of the input tool by measuring the amount of current at a certain distance. The control unit 170 analyzes a hovering event from the signal transferred by the touch sensing unit 133 and then performs a particular function corresponding to the analyzed hovering event.

The touch sensing unit 133 receives a user's event (e.g., a touch event or a hovering event) for interworking applications while respective execution screens of two or more applications are displayed through a multi-screen on the display unit 131. In an embodiment of the present invention, when respective execution screens of applications are displayed through a multi-screen, the touch sensing unit 133 receives a user's event (e.g., an application interworking event) for selecting one of such execution screens and then moving to the other.

The touch sensing unit 133 may be formed to convert a pressure applied to a certain point of the display unit 131 or a variation in capacitance produced at a certain point of the display unit 131 into an electric input signal. Depending on a touch type, the touch sensing unit 133 may be formed to detect the pressure of a touch as well as the position and area thereof. When there is a touch input on the touch sensing unit 133, a corresponding signal or signals are transferred to a touch controller (not shown). Then the touch controller processes such a signal or signals and transfers resultant data to the control unit 170. Therefore, the control unit 170 may identify which point of the touch screen 130 is touched.

The audio processing unit 140 transmits to a speaker 141 an audio signal received from the control unit 170, and also transmits to the control unit 170 an audio signal such as voice received from a microphone 143. Under the control of the control unit 170, the audio processing unit 140 converts an audio signal into an audible sound and outputs it to the speaker 141, and also converts an audio signal received from the microphone 143 into a digital signal and outputs it to the control unit 170.

The speaker 141 outputs audio data received from the wireless communication unit 110, audio data received from the microphone 143, or audio data stored in the memory unit 150 in a call mode, a message mode, a messenger mode, a recording mode, a speech recognition mode, a broadcast receiving mode, a media content (e.g., a music or video file) playback mode, a multi-screen mode, or the like. The speaker 141 also outputs a sound signal associated with a particular function (e.g., the execution of a multi-screen, the interworking of applications, the arrival of an incoming call, the capture of an image, the playback of a media content file, etc.) performed in the user device.

The microphone 143 processes a received sound signal into electric voice data in a call mode, a message mode, a messenger mode, a recording mode, a speech recognition mode, a multi-screen mode, or the like. In a call mode, the processed voice data is converted into a suitable form for transmission to a base station through the mobile communication module 111. The microphone 143 may have various noise removal algorithms for removing noise from a received sound signal.

The memory unit 150 stores a program associated with processing and controlling operations of the control unit 170 and temporarily stores data (e.g., attribute information, contact information, a message, chatting data, media content such as an audio, a video, an image, etc.) inputted or to be outputted. The memory unit 150 may also store the frequency of using a particular function (e.g., the frequency of using a specific application, an attribute of each application, or media content, etc.), the priority (e.g., according to attributes) of a particular function, and the like. Further, the memory unit 150 may store vibration and sound data having specific patterns and to be outputted in response to a touch input on the touch screen. Particularly, in an embodiment of this disclosure, the memory unit 150 may store attributes of applications, an inherent attribute when any application acts as a main application, an associative attribute when any application acts as a target application, and priorities of associative attributes.

Additionally, the memory unit 150 may permanently or temporarily store an operating system of the user device, a program associated with a control operation of the input and display using the touch screen 130, a program associated with a control operation interworked according to the attributes of applications in a multi-screen environment, data created by operations of such programs, and the like. Further, the memory unit 150 may store attribute information of each application required for the interworking of applications in a multi-screen environment. In various embodiments of the present invention, attribute information may be classified into an inherent attribute and an associative attribute, and the memory unit 150 may store the mapping relation between an inherent attribute and an associative attribute with regard to each application. Also, attribute information may be mapped with at least one attribute regarding each application, and if a plurality of attributes are mapped with a single application, priorities of respective attributes may be defined. Attributes such as an inherent attribute and an associative attribute will be described later.

The memory unit 150 may include at least one storage medium such as flash memory, hard disk, micro-type memory, card-type memory (e.g., SD (Secure Digital) card or XD (eXtream Digital) card), DRAM (Dynamic Random Access Memory), SRAM (Static RAM), ROM (Read Only Memory), PROM (Programmable ROM), EEPROM (Electrically Erasable PROM), MRAM (Magnetic RAM), magnetic disk, optical disk, and the like. The user device may interact with any kind of web storage that performs a storing function of the memory unit 150 on the Internet.

The interface unit 160 acts as a gateway to and from all external devices connected to the user device. The interface unit 160 may receive data from any external device or transmit data of the user device to such an external device. Also, the interface unit 160 may receive electric power from any external device and distribute it to respective elements in the user device. The interface unit 160 includes, for example, but is not limited to, a wired/wireless headset port, a charger port, a wired/wireless data port, a memory card port, an audio input/output port, a video input/output port, an earphone port, and a port for connecting any device having an identification module.

The control unit 170 controls the overall operation of the user device. For example, the control unit 170 may perform a control process associated with a voice call, a data communication, or a video call. Particularly, the control unit 170 processes the operation associated with a function to interwork applications on the basis of their attributes, and thus includes a data processing module 171. Specifically, the data processing module 171 includes a window display module 173, an attribute processing module 175, an interworking processing module 177, and an object display module 179. In an embodiment of the present invention, the data processing module 171 may be formed in the control unit 170 or realized separately from the control unit 170. Detailed descriptions about the window display module 173, the attribute processing module 175, the interworking processing module 177, and the object display module 179 will be given below.

In an embodiment of the present invention, the control unit 170 controls an interworking operation of two or more applications which are being executed simultaneously through a multi-screen in the user device. Additionally, the control unit 170 may control an interworking operation of applications which are being executed respectively in different user devices.

The control unit 170 may check a relation between applications on the basis of an attribute defined for each application in the user device, and then interwork such applications according to user-defined priorities of attributes. In an embodiment of the present invention, the control unit 170 may control two or more applications, offered through a multi-screen, to be interworked with each other on the basis of an attribute predefined for each application.

The control unit 170 (e.g., the window display module 173) divides the screen of the user device into at least two windows (or regions) in response to the execution of a multi-screen, and displays separately at least two objects through such windows. In various embodiments of the present invention, the object may indicate an execution screen itself of an application or alternatively indicate various types of data (e.g., text, images, etc.) constituting the execution screen.

While objects of applications are displayed through two or more windows on a multi-screen, the control unit 170 (e.g., the attribute processing module 175) determines whether each application has the ability to be interworked, using an attribute of each application in response to a user's input (e.g., an interworking event).

If the interworking of applications is possible, the control unit 170 (e.g., the interworking processing module 177) identifies the priorities about attributes of the applications and, based on the attributes, interworks the applications.

The control unit 170 (e.g., the object display module 179) processes the display of objects according to the interworking of applications. Further, when such applications are interworked with each other, the control unit 170 (e.g., the object display module 179) determines whether to maintain a multi-screen, depending on a function (or application) of an attribute. If it is determined that a multi-screen is maintained, the control unit 170 (e.g., the object display module 179) controls a specific object associated with the interworking to be displayed through a window of a specific application at which the interworking is targeted. If it is determined that a multi-screen is released, the control unit 170 (e.g., the object display module 179) releases the multi-screen and then controls a specific object associated with the interworking to be displayed on a full screen.

Meanwhile, the control unit 170 according to an embodiment of the present invention may control various operations associated with normal functions of the user device in addition to the above functions. For example, when a specific application is executed, the control unit 170 may control a related operation and display. Further, the control unit 170 may receive input signals corresponding to various touch events through a touch-based input interface (e.g., the touch screen 130) and then control related function operations. Also, based on a wired or wireless communication, the control unit 170 may control the transmission and reception of various data.

The power supply unit 180 receives electric power from an external or internal power source and then supplies it to respective elements of the user device under the control of the control unit 170.

As discussed hereinbefore, the user device may be formed of, at least, the computer-implemented window display module 173 that is configured to divide the screen of the user device into at least two windows (or regions) in response to the execution of a multi-screen, and further to display separately at least two objects through such windows, the computer-implemented attribute processing module 175 that is configured to determine whether each application has the ability to be interworked, using an attribute of each application in response to a user's input (e.g., an interworking event), the computer-implemented interworking processing module 177 that is configured to identify the priorities about attributes of the applications and, based on the attributes, interwork the applications, and the computer-implemented object display module 179 that is configured to process the display of objects (e.g., the result of interworking) caused by the interworking of applications. In some embodiments of the present invention, when such applications are interworked with each other, the object display module 179 determines whether to maintain a multi-screen, depending on a function (or application) of an attribute. If it is determined that a multi-screen is maintained, the object display module 179 controls a specific object associated with the interworking to be displayed through a window of a specific application at which the interworking is targeted. If it is determined that a multi-screen is released, the object display module 179 releases the multi-screen and then controls a specific object associated with the interworking to be displayed on a full screen.

In embodiments of the present invention, the user device may include, but is not limited to, various types of electronic devices that support a particular function disclosed herein and also employ an AP (Application Processor), a GPU (Graphic Processing Unit), and a CPU (Central Processing Unit). For example, the user device may include a tablet PC (Personal Computer), a smart phone, a PMP (Portable Multimedia Player), a media player (e.g., an MP3 player), a PDA (Personal Digital Assistant), a digital broadcasting player, a portable game console, etc., including a mobile communication device that operates based on various communication protocols of various communication systems. Further, the function control method disclosed herein may be applied to a laptop computer (e.g., a notebook), a PC, or any kind of display device such as a digital TV, a DS (Digital Signage), or an LFD (Large Format Display).

Meanwhile, embodiments disclosed herein may be realized, using software, hardware, and a combination thereof, in any kind of computer-readable recording medium. In the case of hardware, embodiments disclosed herein may be realized using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro-controllers, microprocessors, and any other equivalent electronic unit.

In any case, embodiments disclosed herein may be realized in the control unit 170 alone. In the case of software, embodiments disclosed herein may be realized using separate software modules (e.g., the window display module 173, the attribute processing module 175, the interworking processing module 177, or the object display module 179) each of which can perform at least one of functions discussed herein.

Here, a recording medium may include a computer-readable medium that has recorded thereon a program configured to define a control command for displaying an object of an application, for detecting a user input for interworking applications, for determining whether applications can be interworked with each other using an attribute thereof, for identifying the priority of correlatable attributes in applications, for interworking applications on the basis of a selected attribute of the first priority, or for displaying a result object caused by an interworking of applications.

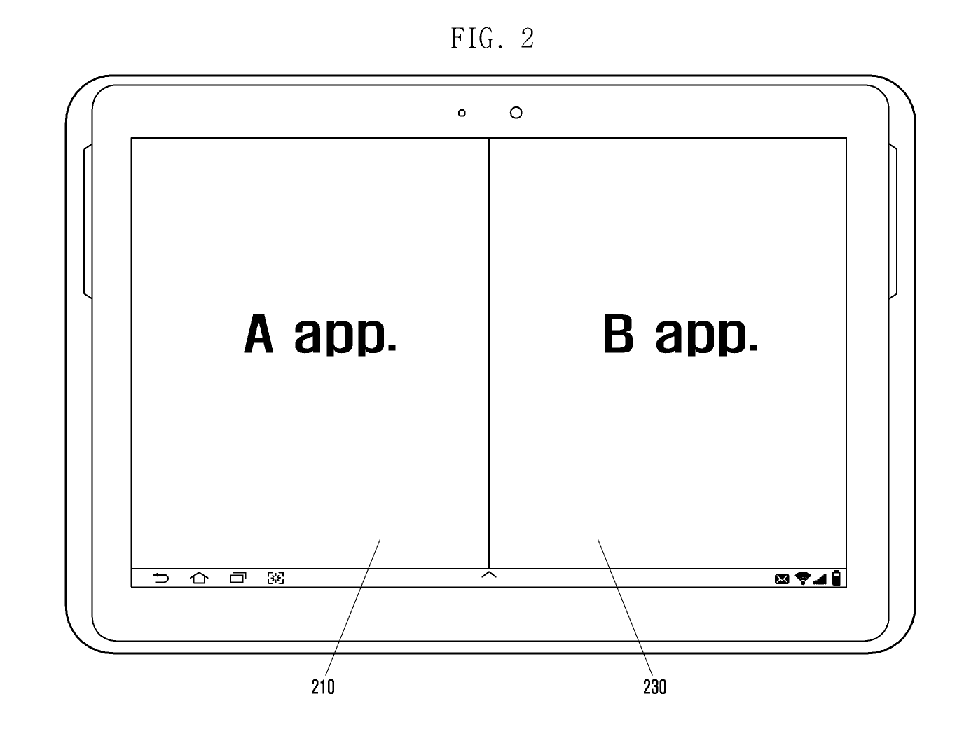

FIG. 2 is a screenshot illustrating a multi-screen of a user device in accordance with an embodiment of the present invention.

Specifically, FIG. 2 shows a multi-screen of the user device formed when two applications (namely, the first application denoted by “A app” and the second application denoted by “B app”) are executed. For example, a user may activate the first and second applications at the same time or at a certain interval. In response to the execution of both applications, the control unit 170 divides the entire window (or region) of the display unit 131 into two windows (or regions) (namely, the first window 210 and the second window 230) and then controls each window 210 and 230 to display a specific object (e.g., an execution screen, graphic information, etc.) of the corresponding application. In an embodiment of the present invention, the control unit 170 may control the first window 210 to display an object of the first application (A app) and also control the second window 230 to display an object of the second application (B app).

Objects displayed on the first and second windows 210 and 230 may include specific graphic information, such as different images or text, independently determined according to a corresponding application. In an embodiment of the present invention, when the first application is a memo application that offers a memo function, the first window 210 may display graphic information associated with the memo application. On the other hand, when the second application is a mail application that offers a mail function, the second window 230 may display graphic information associated with the mail application.

Meanwhile, a specific related operation between two applications being executed simultaneously through a multi-screen may be performed according to an attribute of each application. For example, in a state where two applications are running at the same time on a multi-screen as shown in FIG. 2, the control unit 170 may receive a user input for interworking such applications. Then, in response to the received user input, the control unit 170 determines whether such applications can be interworked using their attributes. If so, the control unit 170 identifies a priority of an attribute and, based on the identified priority, performs an interworking function between the applications.

According to an embodiment, as shown in FIG. 2, a multi-screen environment in which the first application (A app) is executed on the first window 210 and also the second application (B app) is executed on the second window 230 may be assumed. Further, it may be assumed that the first application is a main application to act as the subject of interworking and that the second application is a target application to act as the target of interworking. Namely, it may be assumed that a user takes a certain interworking action (e.g., an interworking event by a drag input, etc.) from the first application to the second application.

The control unit 170 detects a user's action that selects the first application on the first window 210 and then moves to the second application on the second window 230. Then the control unit 170 identifies an attribute (e.g., an inherent attribute to be discussed below) of the first application and an attribute (e.g., an associative attribute to be discussed below) of the second application. Further, by referring to the identified inherent attribute and associative attribute of the first and second applications, the control unit 170 determines whether both applications can be interworked with each other. If so, the control unit 170 may perform, in the second application (i.e., a target application), the identical function (or application) among attributes of each application.

In an embodiment of the present invention, after two applications (e.g., the first and second applications) are interworked with each other as shown in FIG. 2, a current multi-screen environment may be maintained or alternatively released to execute a target application (e.g., the second application) only on a full screen.

Although FIG. 2 shows a multi-screen environment in which two applications are executed simultaneously on two divided windows, this is only an example and is not to be considered as a limitation. In alternative embodiments of the present invention, such a multi-screen environment may be realized to have three or more windows and thus may allow a simultaneous execution of three or more applications.

Meanwhile, each application may have various attributes, which may be classified into inherent attributes and associative attributes, depending on whether such an application operates as a main application or a target application. Namely, at least one attribute may be defined in each application, which may be considered as an inherent attribute or an associative attribute. This will be discussed in detail with reference to Tables 1 and 2 given below.

TABLE 1

| | Inherent Attribute | | | |
|---|---|---|---|---|
| Application | Writing | Capture | Filing | Playback |
| Memo | ◯ | ◯ | ◯ | |
| Gallery | | ◯ | ◯ | |
| Browser | ◯ | ◯ | | |
| Email | ◯ | ◯ | | |
| Message | ◯ | ◯ | | |
| Phonebook | ◯ | ◯ | | |
| Schedule | ◯ | ◯ | | |
| Game | | ◯ | | |
| Map | | ◯ | ◯ | |
| Media Player | | ◯ | ◯ | ◯ |
| File Browser | | | ◯ | ◯ |
| Voice Recording | | | ◯ | ◯ |

In an embodiment of the present invention, an inherent attribute indicates a specific service (or function or application) that can be offered by a main application. For example, as shown in Table 1, a memo application may offer writing, capture and filing functions when operating as a main application and interworking with a target application. A gallery application may offer capture and filing functions when operating as a main application and interworking with a target application. A map application may offer capture and filing functions when operating as a main application and interworking with a target application. A file browser application may offer filing and playback functions when operating as a main application and interworking with a target application. An inherent attribute may also indicate a particular attribute (e.g., an attribute of a service which can be offered by a main application) of a specific service (or function or application) which is offered when a certain application operates a main application.

TABLE 2

| | Associative Attribute | | | |
|---|---|---|---|---|
| Application | 1st Priority | 2nd Priority | 3rd Priority | . . . |
| Memo | Writing | Capture | | |
| Gallery | Capture | | | |
| Email | Writing | Filing | Capture | |
| Message | Writing | Filing | Capture | |
| Phonebook | Writing | Filing | Capture | |
| Schedule | Writing | Filing | Capture | |
| Game | Capture | | | |
| Media Player | Playback | | | |
| File Browser | Playback | Capture | | |

In an embodiment of the present invention, an associative attribute indicates a specific service (or function or application) that can be accepted by a target application, and also may have priorities according to a developer's or user's setting. For example, as shown in Table 2, a memo application may offer, as interworking functions, a writing function with a first priority and a capture function with a second priority when operating as a target application and interworking with a main application. A gallery application may offer a capture function as interworking functions when operating as a target application and interworking with a main application. An email application may offer, as interworking functions, a writing function with a first priority, a filing function with a second priority, and a capture function with a third priority when operating as a target application and interworking with a main application. A file browser application may offer, as interworking functions, a playback function with a first priority and a capture function with a second priority when operating as a target application and interworking with a main application. An associative attribute may also indicate a particular attribute (e.g., an attribute of a service which can be accepted by a target application) of a specific service (or function or application) which is offered when a certain application operates a target application. Such priorities about attributes of an application may be edited by an application developer or a user, thus giving flexibility in the interworking of applications.

In an embodiment of the present invention, each of an inherent attribute and an associative attribute may include all or parts of attributes defined in a corresponding application. Such an inherent attribute and an associative attribute are distinguished from each other only for the purpose of description. In order to interwork applications, the control unit 170 may simply check an inherent attribute in the case of a main application and check an associative attribute in the case of a target application.

Additionally, in an embodiment of the present invention, an inherent attribute of a main application and an associative attribute of a target application may be defined at a platform layer. Therefore, an application developer may add any other function such that an application may be utilized on a multi-screen. Table 3 shows a related example.

TABLE 3

OnRequestForWritingAtMultiscreen( )
{
// todo (inherent attribute (e.g., writing, capture))
}
OnReceiveForWritingAtMultiscreen( )
{
// todo (associative attribute (e.g., playback, capture))
}

Table 3 shows an example of specific code (e.g., Sudo code) for assigning an attribute to an application. Specifically, Table 3 shows an example of an API (Application Program Interface) when a writing function is defined as an attribute (an inherent attribute, an associative attribute) of an application. Thus, it is possible to offer a multi-screen function at a platform level and to offer a function API defined at a platform to a developer. Therefore, by completing such an offered API, any third-party developer can easily realize a multi-screen function.

Meanwhile, as discussed hereinbefore, an inherent attribute and an associative attribute may be defined for each application, and additional information shown in Tables 1 to 3 is for example only. In various embodiments of the present invention, an inherent attribute, an associative attribute, a priority, and an application containing them may be expanded variously.

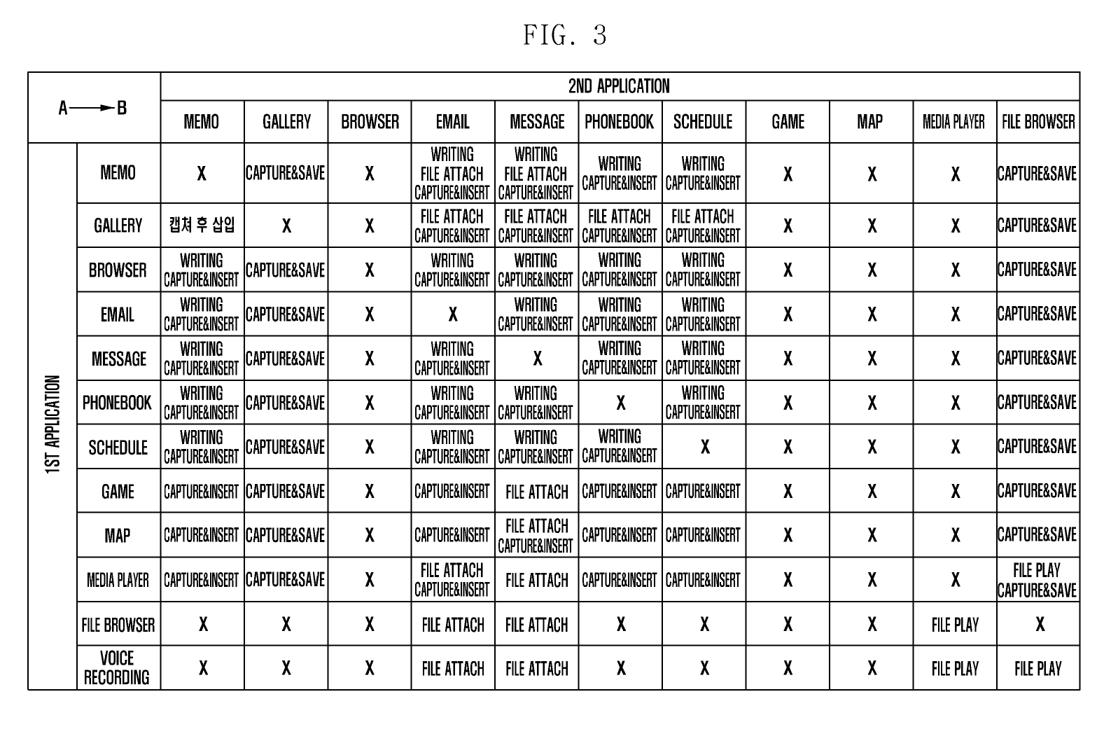

Now, an interworking operation between a main application (e.g., the first application) and a target application (e.g., the second application) on a multi-screen will be discussed with reference to FIG. 3, together with Tables 1 and 2.

FIG. 3 is a table illustrating examples of interworking applications according to attributes defined in a user device in accordance with an embodiment of the present invention.

FIG. 3 shows an example of associated operations from a main application (e.g., the first application) to a target application (e.g., the second application) in a multi-screen environment. Namely, FIG. 3 shows an example of interworked functions to be executed when two applications are interworked with each other.

For example, a memo application acting as a main application may have an inherent attribute of writing, capture and filing functions as shown in Table 1, and an email application acting as a target application may have an associative attribute of writing, filing and capture functions as shown in Table 2. When there is a request for an interworking operation from the memo application to the email application, the control unit 170 analyzes a common attribute between the memo application and the email application. In an embodiment, the control unit 170 determines whether any attribute (e.g., an inherent attribute such as writing, filing or capture) of the memo application is an acceptable attribute (e.g., an associative attribute such as writing, filing or capture) of the email application. The control unit 170 determines, based on a common (or identical) attribute (i.e., writing, filing and capture in this case), that a certain attribute of the memo application is connectable with the email application, and then interworks the memo application to the email application by using a specific attribute (i.e., writing in this case) having a first priority on the basis of the priority (i.e., in the order of writing, filing and capture in this case) about such an attribute of the email application. Referring to FIG. 3, depending on the priority of an associative attribute of the email application among all attributes (e.g., writing, file attaching, and insertion after capture) connectable between the memo application and the email application, a writing function may be performed at the email application on the basis of an object of the mail application.

Meanwhile, the control unit 170 may take no action or perform any user-defined operation when an attribute of the main application is not connectable with the target application. Now, a related example will be described using a phonebook application and a map application.

For example, a phonebook application acting as a main application may have an inherent attribute of writing and capture functions as shown in Table 1, and a map application acting as a target application may have no attribute as shown in Table 2. When there is a request for an interworking operation from the phonebook application to the map application, the control unit 170 analyzes a common attribute between the phonebook application and the map application. In an embodiment, the control unit 170 determines whether any attribute (e.g., an inherent attribute such as writing or capture) of the phonebook application is an acceptable attribute (e.g., no associative attribute) of the map application. The control unit 170 determines, based on no common (or identical) attribute, that any attribute of the phonebook application is not connectable with the map application, and then takes no action or outputs an error message through a popup window according to a user's setting.

In contrast, a map application acting as a main application may have an inherent attribute of capture and filing functions as shown in Table 1, and a phonebook application acting as a target application may have an associative attribute of writing, filing and capture functions as shown in Table 2. When there is a request for an interworking operation from the map application to the phonebook application, the control unit 170 analyzes a common attribute between the map application and the phonebook application. In an embodiment, the control unit 170 determines whether any attribute (e.g., an inherent attribute such as capture or filing) of the map application is an acceptable attribute (e.g., an associative attribute such as writing, filing or capture) of the phonebook application. The control unit 170 determines, based on a common (or identical) attribute (i.e., capture and filing in this case), that a certain attribute of the map application is connectable with the phonebook application, and then interworks the map application to the phonebook application by using a specific attribute (i.e., filing in this case) having a first priority on the basis of the priority (i.e., in the order of filing and capture in this case) about such an attribute of the phonebook application. In FIG. 3, depending on the priority of an associative attribute of the phonebook application among all attributes (e.g., insertion after capture) connectable between the map application and the phonebook application, an insertion-after-capture function may be performed at the phonebook application on the basis of an object of the map application.

Meanwhile, although FIG. 3 shows that no interworking operation is performed when a main application and a target application are the same application, in various embodiments of the present invention two identical applications can be executed simultaneously through a multi-screen. In this case, since there is a common attribute, a specific function may be selected and performed according to an inherent attribute, an associative attribute, and a priority in such an application. In an embodiment, it may be supposed that a memo application is executed separately through the first and second windows 210 and 230. Further, the memo application acting as a main application may have an inherent attribute of writing, capture and filing functions as shown in Table 1, and also the memo application acting as a target application may have an associative attribute of writing and capture functions as shown in Table 2. Therefore, the control unit 170 determines, based on a common (or identical) attribute (i.e., writing and capture in this case), whether the memo applications can be interworked, and then interworks an object of the memo application on the first window 210 to the memo application on the second window 230 according to the priority (i.e., in the order of writing and capture in this case) about attributes of the memo application. In this case, depending on the priority of an associative attribute of the memo application on the second window 230 among all attributes (e.g., writing and capture) connectable between the memo application on the first window 210 and the memo application on the second window 230, a writing function may be performed at the memo application on the second window 230 on the basis of an object of the memo application on the first window 210.

As discussed above, in various embodiments of the present invention, a user input (e.g., an interworking event) based on a specific action (e.g., a drag action) may happen from a main application (e.g., the first application on the first window 210 as shown in FIG. 2) to a target application (e.g., the second application on the second window 230 as shown in FIG. 2) while two applications are executed in a multi-screen environment. In response to such a user input, the control unit 170 determines whether an attribute (e.g., an inherent attribute as shown in Table 1) of the main application is an acceptable attribute (e.g., an associative attribute as shown in Table 2) to the target application. Then the control unit 170 may take no action in case of a non-connectable attribute (namely, ignore an interworking event) or, in case of any connectable attribute, control an object of the main application to be interworked with the target application according to the priority of attribute.

Further, in various embodiments of the present invention, when a certain function is performed by the above-discussed interworking of applications, a multi-screen may be still maintained or alternatively released such that the target application only may be executed on a full screen.

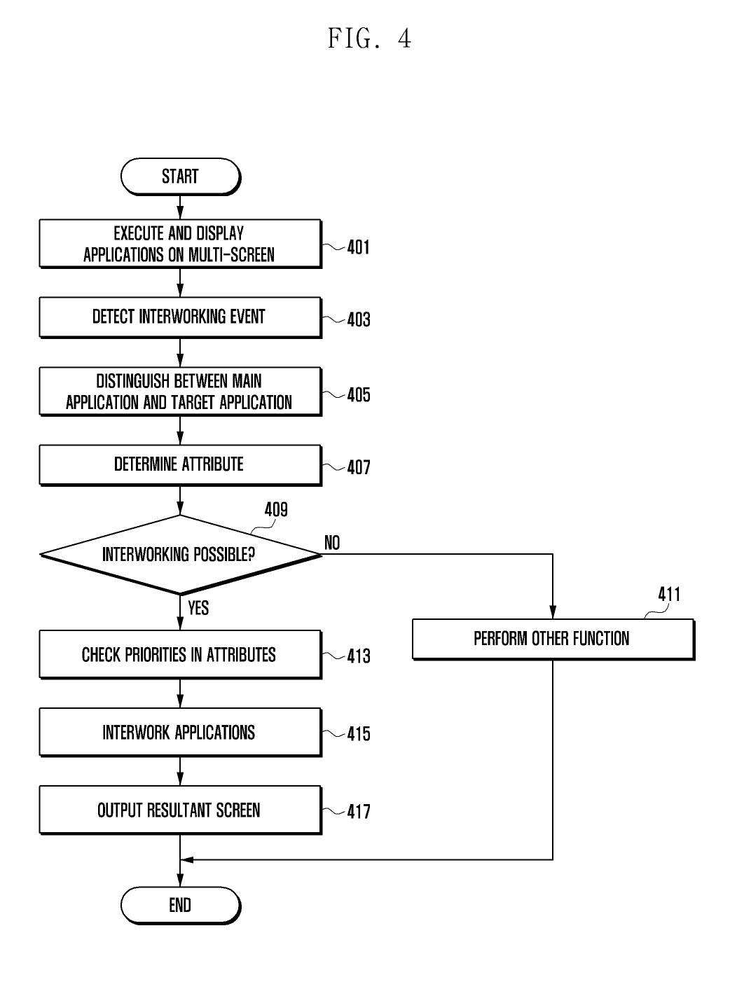

FIG. 4 is a flowchart illustrating a method for interworking applications in a user device in accordance with an embodiment of the present invention.

Referring to FIG. 4, at step 401, the control unit 170 controls a simultaneous execution and display of two (or more) applications through a multi-screen. For example, as shown in FIG. 2, the control unit 170 may offer a multi-screen divided into the first window 210 and the second window 230 in response to a user's request and then controls respective execution screens of two applications to be displayed on corresponding windows 210 and 230 of the multi-screen.

While such applications are displayed on the windows, the control unit 170 detects an interworking event at step 403. For example, the control unit 170 detects an action to select a specific application displayed on one of the windows and then moves toward another application displayed on the other window. In an embodiment, a user inputs a user gesture to select an object of an application on the first window 210 and then to moves toward an application on the second window 230. Then the control unit 170 may determine that this gesture is an interworking event.

When detecting an interworking event, the control unit 170 distinguishes between a main application and a target application at step 405. For example, from among applications operating in response to an interworking event, the control unit 170 identifies an application offering an object and an application receiving an object. Then the control unit 170 determines that an application offering an object is a main application and also that an application receiving an object is a target application. In an embodiment, a user inputs a user gesture to select an object of an application on the first window 210 and then to moves toward an application on the second window 230. In this case, the control unit 170 determines that an application on the first window 210 is to operate as a main application and also that an application on the second window 230 is to operate as a target application.

Additionally, at step 407, the control unit 170 determines attributes defined in the main application and the target application. For example, as discussed above with reference to FIG. 2 and Tables 1 to 3, the control unit 170 analyzes an inherent attribute of the main application and an associative attribute of the target application.

Then, at step 409, based on attributes of the main application and the target application, the control unit 170 determines whether an interworking between applications is possible. For example, the control unit 170 determines, through comparison, whether there is a common (or identical) attribute between an inherent attribute of the main application and an associative attribute of the target application.

If it is determined that an interworking between the main application and the target application is not possible at step 409, the control unit 170 performs any other particular function at step 411. For example, if an attribute of the main application is not a connectable attribute to the target application, the control unit 170 may take no action. Namely, the control unit 170 may ignore a user's interworking event and maintain a multi-screen state. Alternatively, when output of any error message is defined in a user's setting, the control unit 170 outputs an error message through a popup window to notify the impossibility of interworking from the main application to the target application. In this case, a multi-screen may be still maintained.

If it is determined that an interworking between the main application and the target application is possible at step 409, the control unit 170 checks an attribute priority of the target application at step 413. For example, the control unit 170 may check priorities in associative attributes of the target application which are identical to inherent attributes of the main application.

Then, at step 415, based on a specific attribute having the first priority in the target application, the control unit 170 controls an interworking between applications. For example, the control unit 170 may control an object of the main application to be executed through the target application. At this time, the control unit 170 performs a particular function using an object of the main application at the target application on the basis of a specific associative attribute having the first priority in the target application.

Then, at step 417, the control unit 170 outputs a resultant screen caused by an interworking between the main application and the target application. For example, when a particular function is performed by an interworking between the main application and the target application, the control unit 170 maintains a multi-screen or alternatively releases a multi-screen such that only the target application may be executed on a full screen. In an embodiment, whether to maintain a multi-screen may be determined by a user's setting.

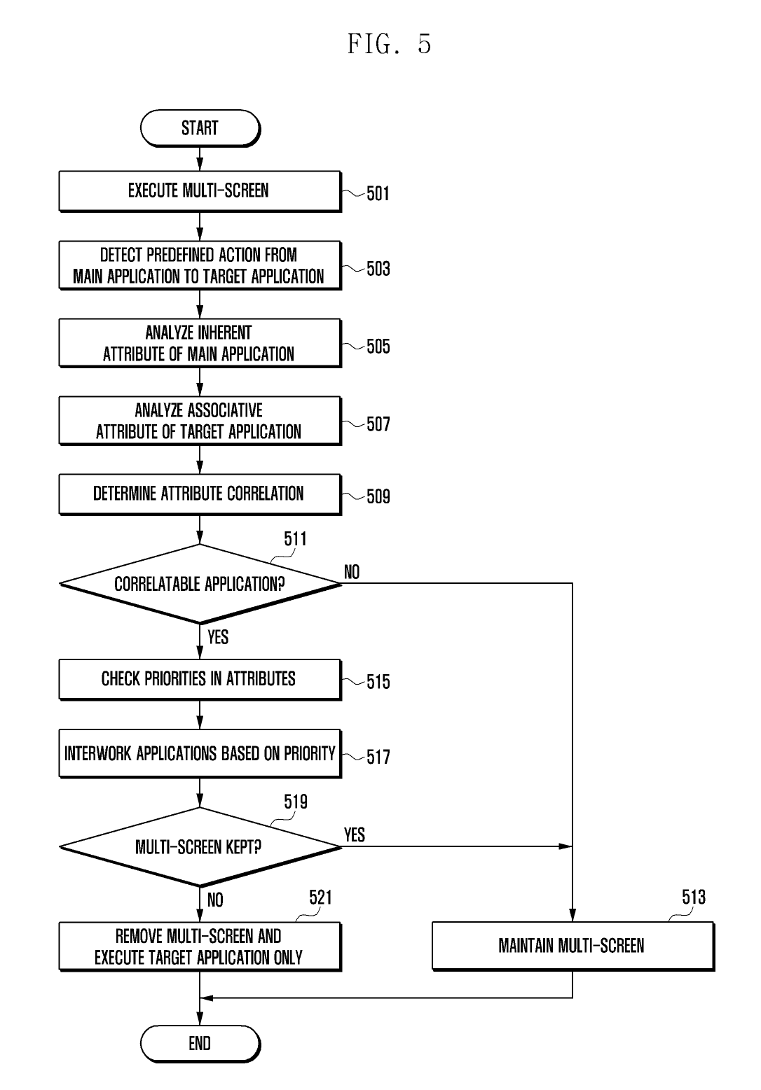

FIG. 5 is a flowchart illustrating a detailed process of interworking applications in a user device in accordance with an embodiment of the present invention.

Referring to FIG. 5, at step 501, the control unit 170 executes a multi-screen. For example, the control unit 170 executes a multi-screen divided into at least two windows in response to a user's request for executing at least two applications, and then controls each window of the multi-screen to separately display an object of such an application. In an embodiment, while the first application is executed on a full screen, a user's manipulation for executing the second application on the basis of a multi-screen environment may be received. Then, in response to such a user's manipulation, the control unit 170 divides a full screen into two windows, displays an object of the first application on one window (e.g., the first window 210), and displays an object of the second application on the other window (e.g., the second window 230).

Then, at step 503, the control unit 170 detects a user's predefined action (e.g., a predefined interworking event) which is taken from a main application to a target application. For example, a user may input a user gesture (e.g., a drag) to select an object (all or parts thereof) of one of two applications being executed through a multi-screen and then moves it toward the other application. Namely, a user may input an interworking event that corresponds to a specific action predefined for an interworking between applications. In an embodiment, such an interworking event may be a drag input to move an object displayed on one window toward the other window. Alternatively, the interworking event may be inputted, based on a multi-touch. For example, a user may select (e.g., touch) a window of the target application and further drag an object displayed on a window of the main application toward the selected (e.g., touched) window.

Namely, an interworking event according to an embodiment of the present invention may happen on the basis of a multi-touch that includes the first input (e.g., a touch) for selecting the target application and the second input (e.g., a drag) for moving from a window of the main application to a window of the target application while the first input is still maintained. Here, the control unit 170 recognizes that an application on a window in which an object is selected is a main application and that an application on another window to which the selected object is moved is a target application. According to an embodiment, in response to a user's interworking event, the control unit 170 distinguishes between a main application offering an object and a target application receiving an object, and then recognizes the object-offering application and the object-receiving application as a main application and a target application, respectively.

When any interworking event for interworking applications is detected, the control unit 170 analyzes an inherent attribute of the main application and an associative attribute of the target application at steps 505 and 507. For example, as discussed above with reference to FIG. 2 and Tables 1 to 3, the control unit 170 analyzes an inherent attribute of the main application and an associative attribute of the target application from among attributes defined in respective applications.

Then, at step 509, the control unit 170 determines an attribute correlation between the main application and the target application. For example, the control unit 170 may determine, by comparing an inherent attribute of the main application with an associative attribute of the target application, whether there is a common (or identical) attribute between them.

Then, at step 511, the control unit 170 determines whether the main application and the target application can be correlated with each other. For example, based on the attribute correlation between the main application and the target application, if there is any common (or identical) attribute, the control unit 170 may determine that both applications can be correlated. In contrast, if there is no common (or identical) attribute, the control unit 170 may determine that both applications cannot be correlated.

If it is determined that the main application and the target application are not correlatable applications at step 511, the control unit 170 maintains a multi-screen at step 513. For example, the control unit 170 maintains a current multi-screen state executed previously at step 501, and also outputs an error message as discussed above.

If it is determined that the main application and the target application are correlatable applications at step 511, the control unit 170 checks an attribute priority at step 515. For example, the control unit 170 may check priorities in associative attributes of the target application which are identical to inherent attributes of the main application.

Then, at step 517, based on a specific attribute having the first priority in the target application, the control unit 170 controls a specific object selected in the main application to be executed through the target application. At this time, the control unit 170 performs a particular function using an object of the main application at the target application on the basis of a specific associative attribute having the first priority in the target application.

Then, at step 519, the control unit 170 determines whether to keep a multi-screen when the main application and the target application are interworked. For example, a user may predefine whether a multi-screen will be maintained or not during an interworking of applications, and the control unit 170 maintains or releases a multi-screen according to a user's setting.

If a multi-screen is set to be maintained at step 519, the control unit 170 maintains a current multi-screen at step 513. For example, the control unit 170 displays a function execution screen using an object of the main application through a window of the target application in a state where a current multi-screen is maintained.

If a multi-screen is set to be released at step 519, the control unit 170 removes a multi-screen at step 521. For example, the control unit 170 removes a current multi-screen to convert a window of the target application into a full screen, and then displays a function execution screen using an object of the main application on a full screen.

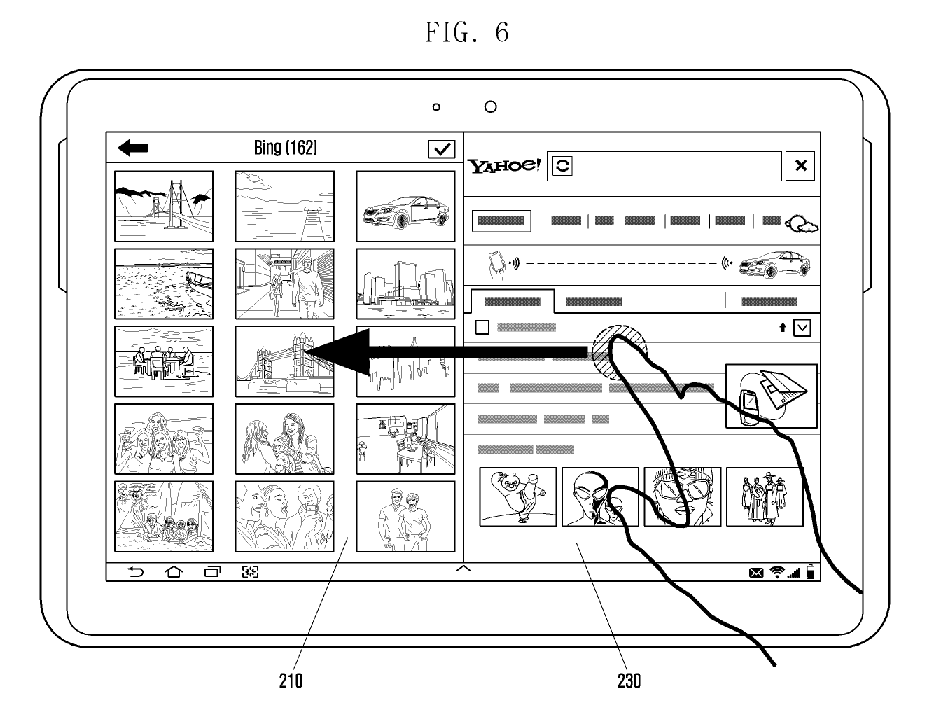

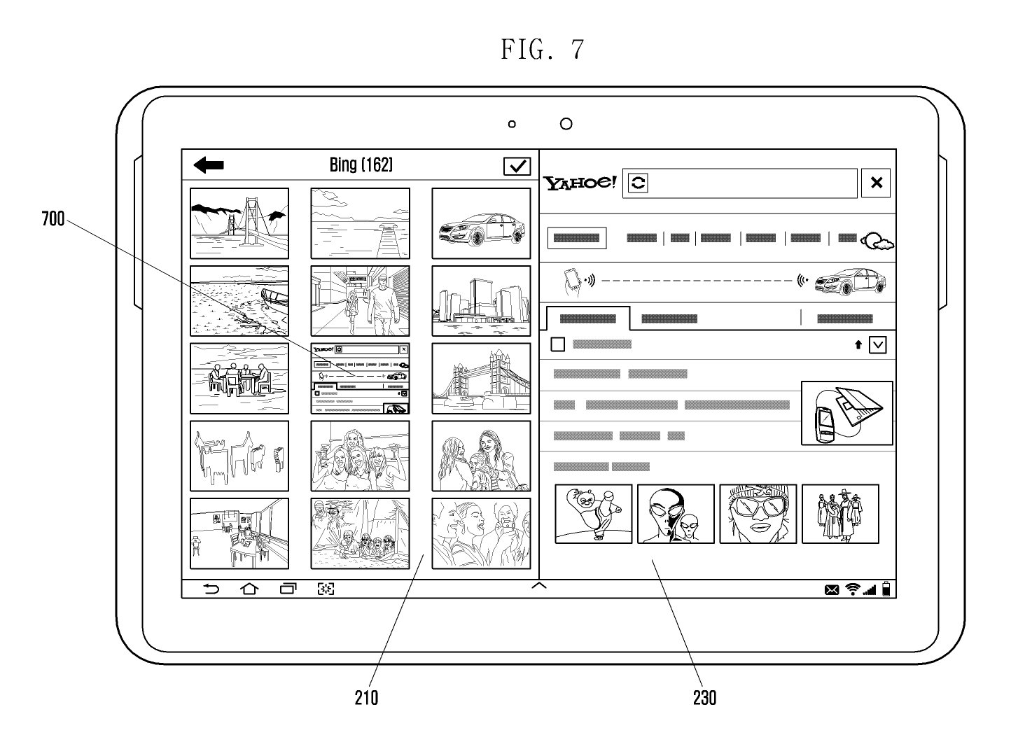

FIGS. 6 and 7 show screenshots illustrating an operating example of interworking applications in a multi-screen of the user device in accordance with an embodiment of the present invention.

Specifically, FIG. 6 shows a screenshot of the user device in case a user executes two applications through a multi-screen. In this embodiment shown in FIG. 6, as an example, the two applications are a gallery application and a browser application. Further, the objects (e.g., photo images and a list thereof) of the gallery application are displayed on the first window 210, and the objects (e.g., a webpage screen containing text and images) of the browser application are displayed on the second window 230. Also, the browser application is a main application and the gallery application is a target application. Further, it is assumed that the browser application has writing and capture functions defined as an inherent attribute as shown in Table 1 and that the gallery application has a capture function defined as an associative attribute as shown in Table 2.

As shown in FIG. 6, a user selects (e.g., touches) the second window 230 in which the browser application is executed, and then moves (e.g., drags) toward the first window 210 in which the gallery application is executed. Namely, FIG. 6 shows a state in which a user inputs an interworking event for executing an object of the browser application through the gallery application. Although FIG. 6 shows that a user input for interworking applications, namely an interworking event, is a drag input, this is an example only and is not to be considered as a limitation. Various input techniques may be used for an interworking event. In an embodiment, a user may produce an interworking event by inputting a drag from the main application to the target application while selecting (e.g., touching) the target application (e.g., the browser application) to be executed.

When any interworking event for interworking applications from the browser application to the gallery application is inputted as shown in FIG. 6, the control unit 170 analyzes an inherent attribute (e.g., writing and capture) of the browser application and an associative attribute (e.g., capture) of the gallery application. Then the control unit 170 identifies a specific attribute (e.g., capture), from among the associative attributes of the gallery application, which is identical to the inherent attribute of the browser application. And then, based on the priority of the identified attribute, the control unit 170 controls an interworking operation for applications.

For example, the control unit 170 recognizes a capture function in response to an interworking event that progresses from the browser application to the gallery application. Therefore, the control unit 170 captures an object (e.g., a current screen) of the browser application and then displays the captured object (e.g., a captured image) through the gallery application. This is shown in FIG. 7.

As shown in FIG. 7, an image 700 which corresponds to a captured object of the browser application displayed on the second window 230 is offered through the gallery application on the first window 210. Namely, when an interworking is made from the browser application to the gallery application, an image is created by capturing an object of the browser application through a capture function selected according to an attribute priority of the gallery application. This image 700 created using the selected function of the gallery application is added to a gallery list.

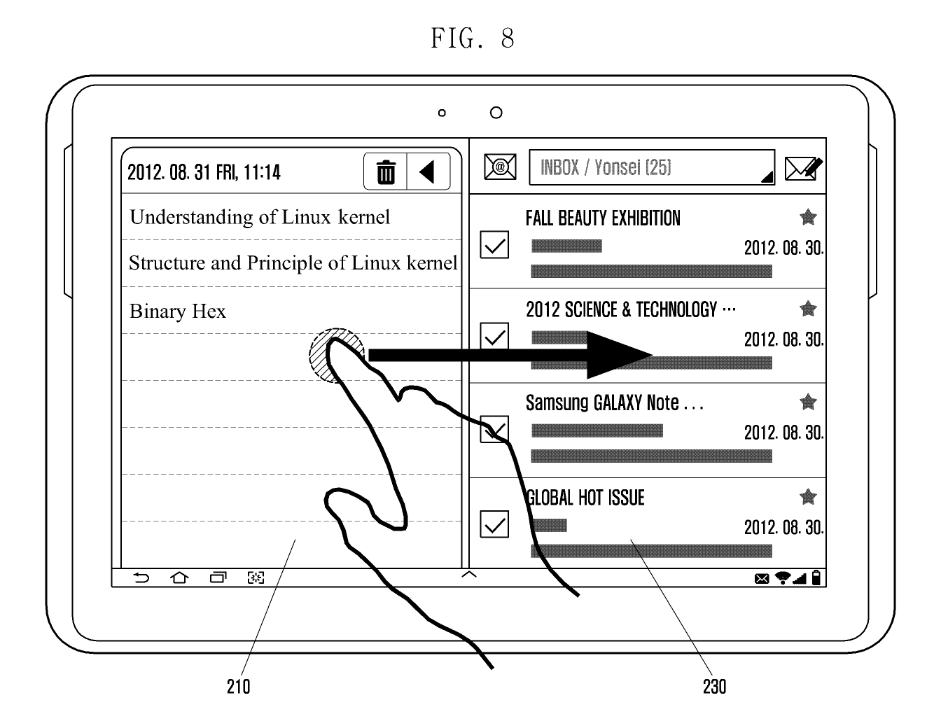

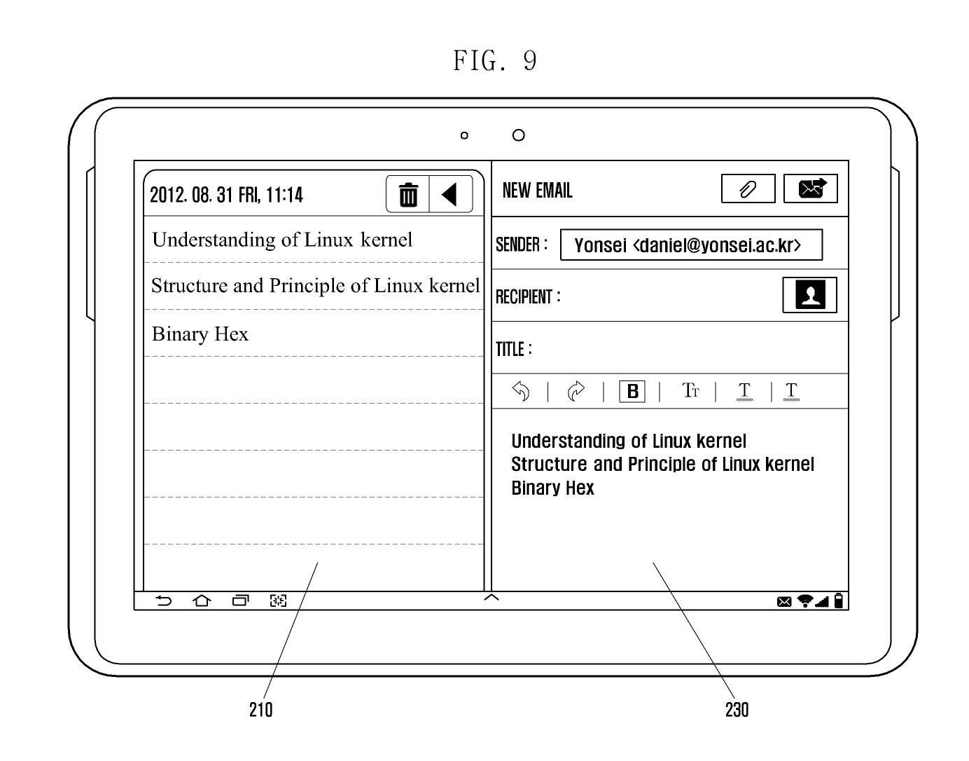

FIGS. 8 and 9 show screenshots illustrating an operating example of interworking applications in a multi-screen of the user device in accordance with another embodiment of the present invention.

Specifically, FIG. 8 shows a screenshot of the user device when a user executes two applications through a multi-screen. In this embodiment shown in FIG. 8, as an example, the two applications are a memo application and an email application. Further, the objects (e.g., user created text) of the memo application are displayed on the first window 210 and that objects (e.g., an email list) of the email application are displayed on the second window 230. Also, the memo application is a main application and the email application is a target application. Further, it is assumed that the memo application has writing, capture and filing functions defined as an inherent attribute as shown in Table 1 and that the email application has a writing, filing and capture functions defined as an associative attribute as shown in Table 2.

As shown in FIG. 8, a user selects (e.g., touches) the first window 210 in which the memo application is executed, and then moves (e.g., drags) toward the second window 230 in which the email application is executed. Namely, FIG. 8 shows a state in which a user inputs an interworking event for executing an object of the memo application through the email application. Although FIG. 8 shows that a user input for interworking applications, namely an interworking event, is a drag input, this is an example only and is not to be considered as a limitation. Various input techniques such as a multi-touch discussed previously may be used for an interworking event.

When any interworking event for interworking applications from the memo application to the email application is inputted as shown in FIG. 8, the control unit 170 analyzes an inherent attribute (e.g., writing, capture, and filing) of the memo application and an associative attribute (e.g., writing, filing, and capture) of the email application. Then the control unit 170 identifies a specific attribute (e.g., writing, capture, and filing), from among the associative attributes of the email application, which is identical to the inherent attribute of the memo application. And then, based on the priority of the identified attribute (writing with the first priority, filing with the second priority, and capture with the third priority), the control unit 170 may control an interworking operation for applications.

For example, the control unit 170 recognizes a writing function in response to an interworking event that progresses from the memo application to the email application. Therefore, the control unit 170 displays an object (e.g., user created text) of the memo application through the email application. This is shown in FIG. 9.

As shown in FIG. 9, an object (e.g., text) of the memo application displayed on the first window 210 is offered through the email application on the second window 230. Namely, when an interworking is made from the memo application to the email application, an object of the memo application may be written through the email application by a writing function selected according to an attribute priority of the email application. In an embodiment, the control unit 170 copies text in the memo application, activates a mail creation function of the email application, and then pastes the copied text to a created mail. As shown in FIG. 9, the control unit 170 displays a screen associated with a writing function of the email application on the second window 230 in response to the activation of a writing function in the email application, and then automatically inserts an object of the memo application into the content of an email. Also, the control unit 170 may further automatically insert information about a sender.

Additionally, FIG. 8 shows the second window 230 that displays a list of transmitted or received emails in the email application, whereas FIG. 9 shows the second window 230 that displays a new email page that appears through a screen conversion caused by an email writing function of the email application activated in response to an interworking event. This is, however, an example only and is not to be considered as a limitation. Even in a state where a new email page has been already displayed on the second window 230, the above-discussed operation may be performed in response to a user's interworking event.

Meanwhile, although not shown in the drawings, an alternative to FIGS. 8 and 9 may be that the gallery application is a main application and that the email application is a target application. In this alternative case, a file attaching function may be selected as an attribute having the first priority to be executed between the gallery application and the email application, based on the above-discussed Tables 1 and 2 and FIG. 3. Therefore, in response to a user input for moving from the gallery application to the email application, the control unit 170 automatically adds, as an attached file, a selected object (e.g., a specific image) in the gallery application to a current email.

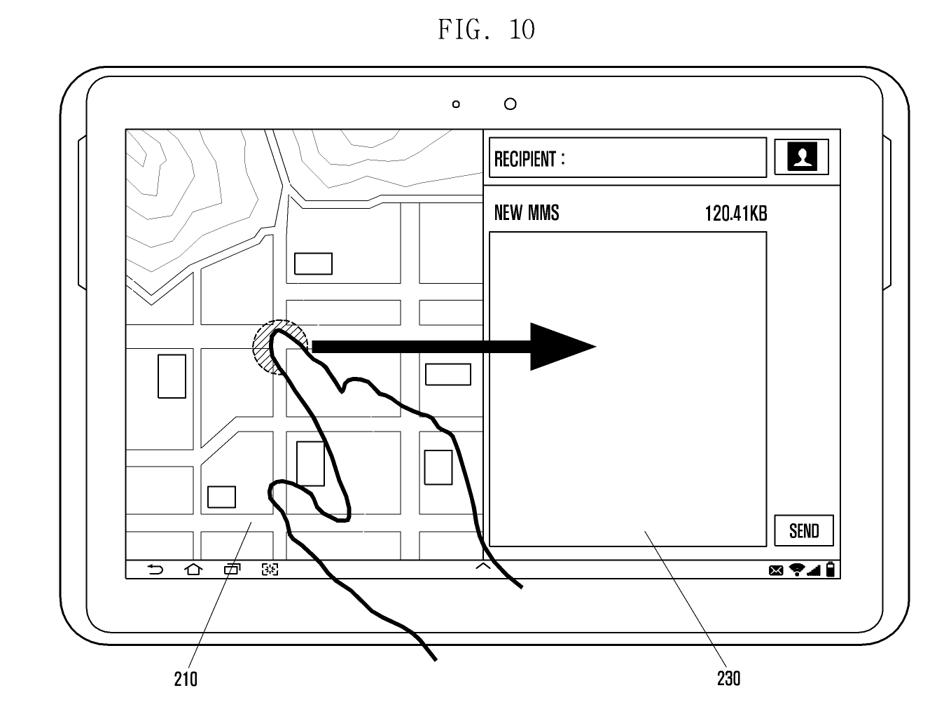

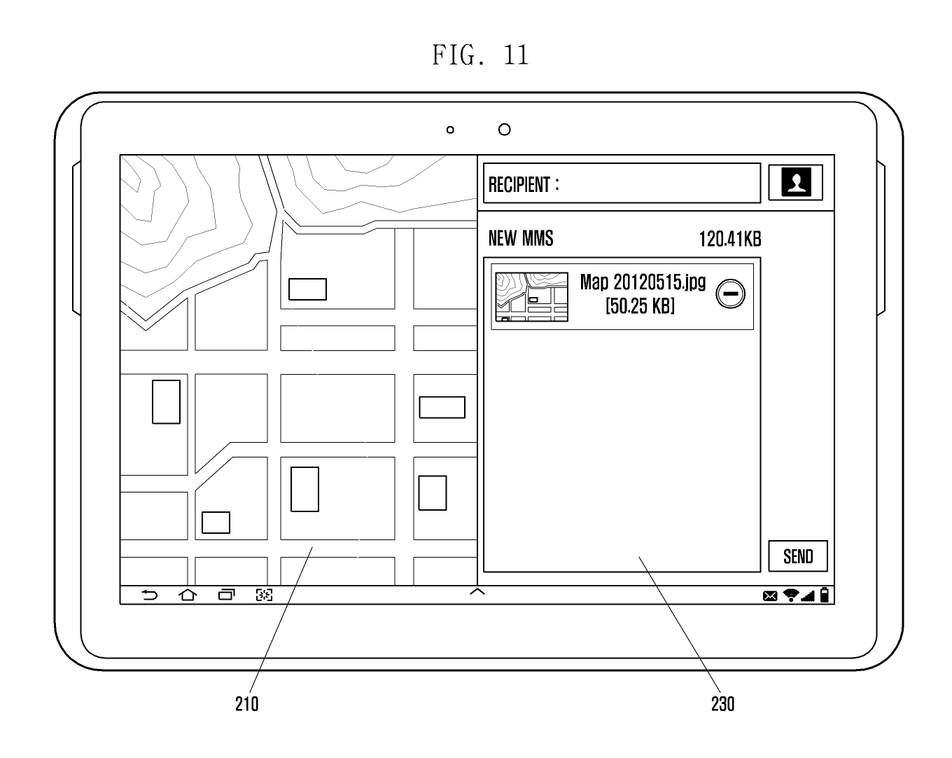

FIGS. 10 and 11 show screenshots illustrating an operating example of interworking applications in a multi-screen of the user device in accordance with still another embodiment of the present invention.

Specifically, FIG. 10 shows a screenshot of the user device when a user executes two applications through a multi-screen. In this embodiment shown in FIG. 10, as an example, two applications are a map application and a message application. The objects (e.g., a map image) of the map application are displayed on the first window 210 and objects (e.g., a new message page) of the message application are displayed on the second window 230. Also, the map application is a main application and that the message application is a target application. Further, it is assumed that the map application has capture and filing functions defined as an inherent attribute as shown in Table 1 and that the message application has a writing, filing and capture functions defined as an associative attribute as shown in Table 2.

As shown in FIG. 10, a user selects (e.g., touches) the first window 210 in which the map application is executed, and then moves (e.g., drags) toward the second window 230 in which the message application is executed. Namely, FIG. 10 shows a state in which a user inputs an interworking event for executing an object of the map application through the message application. Although FIG. 10 shows that a user input for interworking applications, namely an interworking event, is a drag input, this is only an example and is not to be considered as a limitation. Various input techniques such as a multi-touch discussed previously may be used for an interworking event.

When any interworking event for interworking applications from the map application to the message application is inputted as shown in FIG. 10, the control unit 170 analyzes an inherent attribute (e.g., capture and filing) of the map application and an associative attribute (e.g., writing, filing, and capture) of the message application. Then the control unit 170 identifies a specific attribute (e.g., filing and capture), from among the associative attribute of the message application, which is identical to the inherent attribute of the map application. And then, based on the priority of the identified attribute (writing with the first priority, filing with the second priority, and capture with the third priority), the control unit 170 controls an interworking operation for applications.

For example, the control unit 170 recognizes a filing function in response to an interworking event that progresses from the map application to the message application. In an embodiment, even though a writing function has the first priority among writing, filing, and capture functions defined as an associative attribute of the message application, the priority is determined among capture and filing functions which are identical to functions defined as an inherent attribute of the map application. Therefore, in the case of FIG. 10, a filing function may be selected in response to an interworking from the map application to the message application, and the control unit 170 may display an object (e.g., a map image) of the map application through the message application. This is shown in FIG. 11.

As shown in FIG. 11, an object (e.g., a map image) of the map application displayed on the first window 210 is offered through the message application on the second window 230. Namely, when an interworking is made from the map application to the message application, an object of the map application may be created as a file (e.g., captured and then converted into a file) and then attached as an attached file to the message application by a filing function selected according to an attribute priority of the message application. In an embodiment, the control unit 170 captures a map image in the map application, converts the captured map image into a file, activates a message creation function of the message application, and then attaches the map image file to a current message.

Meanwhile, although not shown in the drawings, an alternative to FIGS. 10 and 11 may be that the first priority is assigned to a capture function in an associative attribute of the message application. In this alternative case, the control unit 170 captures an object of the map application and then attaches the captured object to a current message.

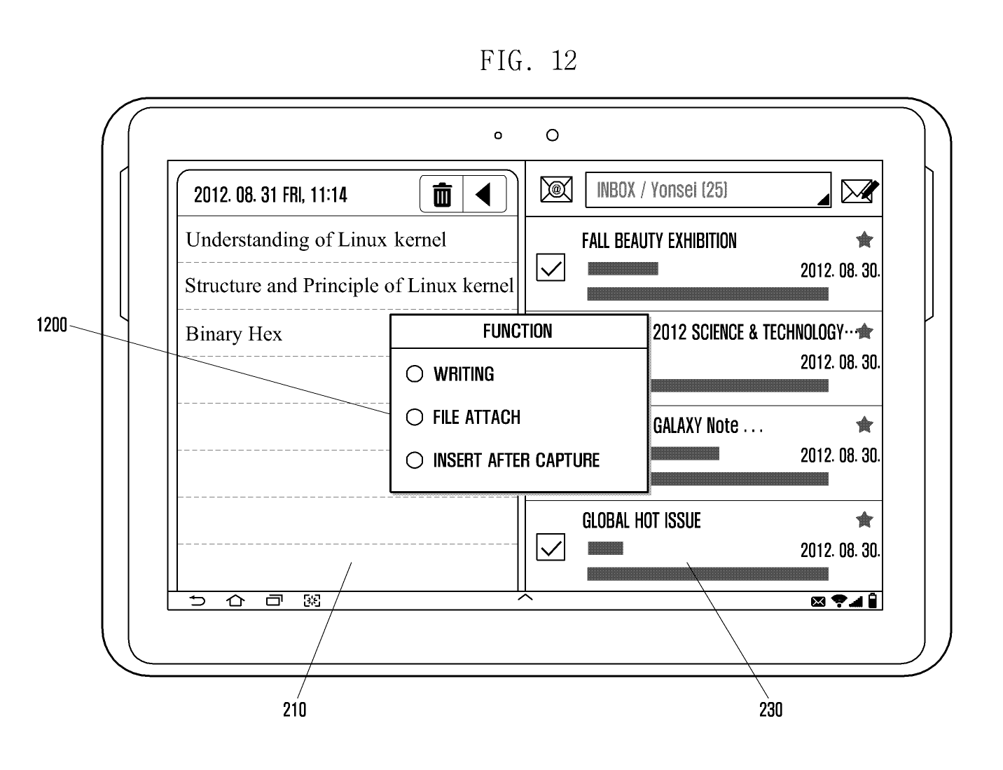

FIG. 12 shows a screenshot illustrating an operating example of interworking applications in a multi-screen of the user device in accordance with another embodiment of the present invention.

Specifically, FIG. 12 shows a screenshot in which the user device offers a correlatable function between a main application and a target application in response to a user's interworking event and then performs an interworking operation by a particular function in response to a user's selection. In this embodiment shown in FIG. 12, it is assumed, as in FIG. 8, that a memo application is a main application and that an email application is a target application.

Therefore, as shown in FIG. 8, an interworking event for interworking from the main application (e.g., the memo application) to the target application (e.g., the email application) may be inputted by a user. Then the control unit 170 checks a correlatable function on the basis of both an inherent attribute of the main application and an associative attribute of the target application.

For example, referring back to FIG. 3, the control unit 170 recognizes writing, file attaching, and insertion-after-capture functions in response to an interworking event that progresses from the memo application to the email application. Then the control unit 170 offers the recognized functions as correlatable functions through a popup window 1200 as shown in FIG. 12. The correlatable functions displayed on the popup window 1200 may be arranged according to the priority of attributes in the target application. If a user selects a desired one of the correlatable functions through the popup window 1200, the control unit 170 performs an interworking between applications. Whether to offer the correlatable functions through the popup window 1200 may be determined depending on a user's setting.

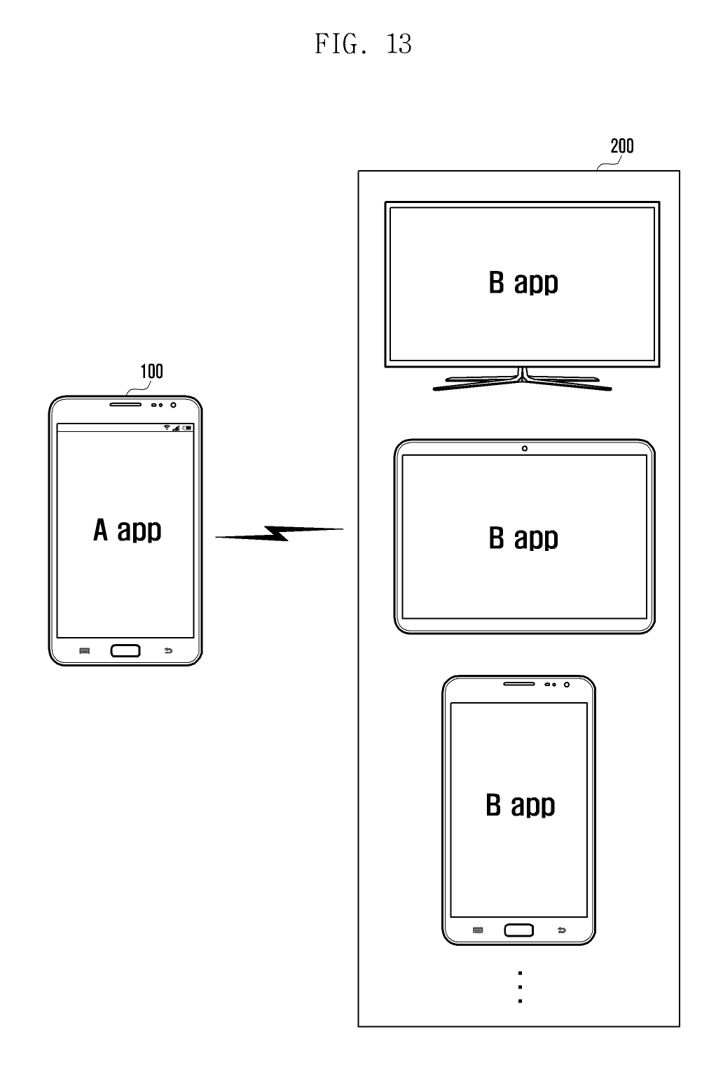

FIG. 13 is a view illustrating an example of interworking an application between user devices in accordance with an embodiment of the present invention.

FIG. 13 shows an example in which the first application (A app) is executed in the first user device 100 and the second application (B app) is executed in the second user device 200. For example, a user (or users) may execute the first and second applications at the same time or at a certain interval through the first and second user devices 100 and 200, respectively. Therefore, in response to the execution of the first application, the control unit of the first user device 100 controls the display unit of the first user device 100 to display, for example, an execution screen, graphic information, etc. of the first application. Similarly, in response to the execution of the second application, the control unit of the second user device 200 controls the display unit of the second user device 200 to display, for example, an execution screen, graphic information, etc. of the second application.

Objects displayed on the first and second user devices 100 and 200 may include specific graphic information, such as different images or text, respectively determined according to the first and second applications. In an embodiment of the present invention, when the first application (A app) is a memo application that offers a memo function, the first user device 100 may display graphic information associated with the memo application on the display unit thereof. On the other hand, when the second application (B app) is a mail application that offers a mail function, the second user device 200 may display graphic information associated with the mail application on the display unit thereof.

As shown in FIG. 13, the first user device 100 may be a smart phone, and the second user device 200 may be a device such as a smart phone, a tablet PC, a PMP, a PDA, etc. or a display device such as a digital TV, a smart TV, LFD, etc.

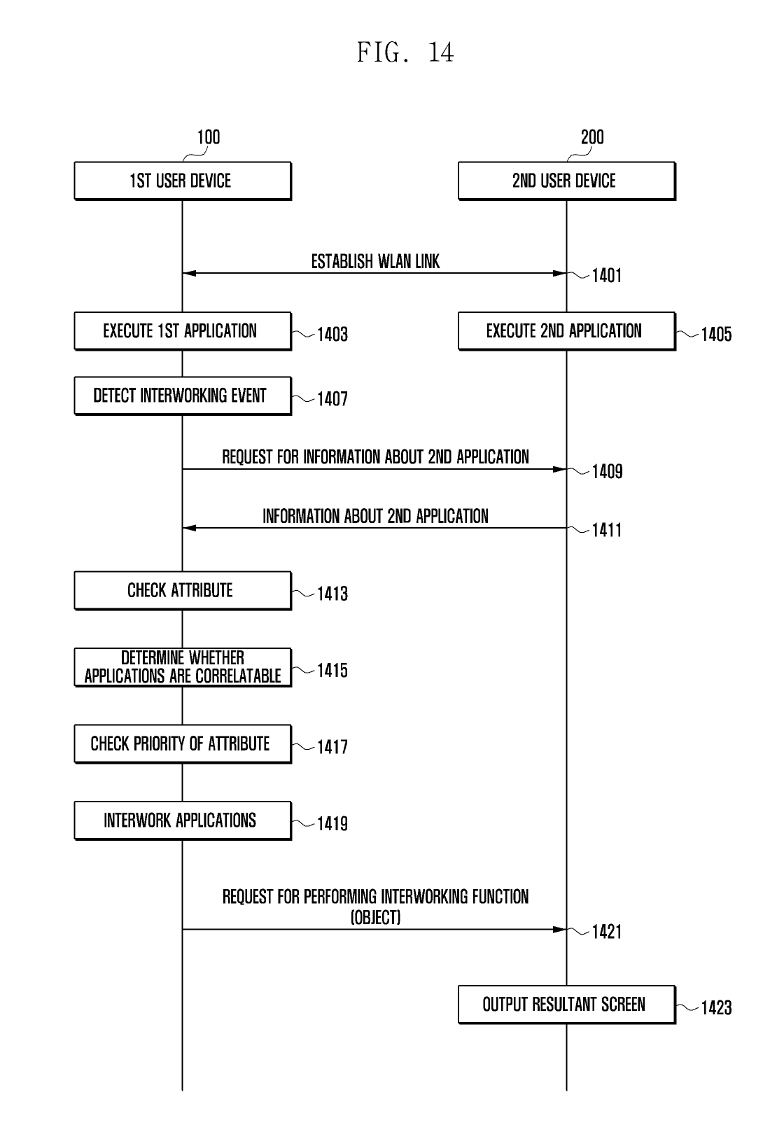

As shown in FIG. 13, in an embodiment of the present invention, a specific operation correlated between applications respectively executed in the first and second user devices 100 and 200 may be performed depending on attributes of such applications. In the following description of FIG. 14, which is a flow diagram illustrating an operating example of interworking applications between user devices in accordance with an embodiment of the present invention, it is assumed that an interworking is made from an application of the first user device 100 to an application of the second user device 200. Namely, the first application (A app) executed in the first user device 100 is a main application, and the second application (B app) executed in the second user device 200 is a target application.

Referring to FIGS. 13 and 14, at step 1401, the first and second user devices 100 and 200 establishes a WLAN link in response to a user's input. This means that the user devices 100 and 200 are connected to each other through a WLAN. For example, one of the first and second user devices 100 and 200 may operate as an Access Point (AP), and the other may operate as a non-AP station. In some embodiments, one or more user devices may operate as a non-AP station.

Additionally, in some embodiments, the WLAN link between the user devices 100 and 200 may be established in response to a user's input for requesting an external interworking function (or application) of applications. For example, to execute such an external interworking function, the user devices 100 and 200 check the on/off state of the WLAN module, control a turn-on process if the WLAN module is in a turn-off state, and perform a process for establishing the WLAN link between them.

After the WLAN link is established, the first and second user devices 100 and 200 execute respective applications in response to a user's request at steps 1403 and 1405. For example, as discussed above, the first user device 100 executes the first application (A app) and then displays a related object, and also the second user device 200 executes the second application (B app) and then displays a related object. Although FIG. 14 shows an example of executing respective applications after the WLAN link is established, such applications may be executed before the WLAN link is established.

The first user device 100 detects, at step 1407, an interworking event for interworking a currently executed application with another application executed in the second user device 200. For example, a user may take a specific action (i.e., an interworking event input) predefined for an application interworking in the first user device 100 in which the first application is being executed. In embodiments of the present invention, such a specific action for an application interworking may include, but is not limited to, a user gesture to select (e.g., based on a touch or a hovering) a screen displaying a main application (e.g., the first application) and then flick out of the screen, a user gesture (e.g., a hand gesture, a device swing gesture, a device rotation gesture, etc.) to trigger a specific sensor designed for an interworking event input, and the like.

At step 1409, the first user device 100 that detects an interworking event transmits a request for attribute information about a currently executed application (e.g., the second application) to the second user device 200. As shown in FIG. 14, the first user device 100 sends, to the second user device 200, a request for attribute information about a target application to be interworked with a main application. In other cases, the first user device 100 may request the second user device 200 to offer an associative attribute of a target application to be interworked with a main application.

At step 1411, when a request for attribute information about a currently executed application (e.g., the second application) is received from the first user device 100, the second user device 200 transmits attribute information about a relevant application to the first user device 100.

At step 1413, when attribute information about an application (e.g., the second application) currently executed in the second user device 200 is received, the first user device 100 checks an attribute (e.g., an inherent attribute) of the first application and an attribute (e.g., an associative attribute) of the second application. Here, the first user device 100 may temporarily store the received attribute information about the second application until an application interworking process is finished.

At step 1415, based on an attribute (e.g., an inherent attribute) of the first application acting as a main application and an attribute (e.g., an associative attribute) of the second application acting as a target application, the first user device 100 determines whether both applications can be correlated.

If both applications can be correlated, at step 1417 the first user device 100 checks an attribute priority on the basis of the attribute information about the second application (i.e., the target application) of the second user device 200. For example, the first user device 100 may select a specific attribute having the first priority from among associative attributes of the second application of the second user device 200 which are identical to inherent attributes of the first application.

Then, at steps 1419 and 1421, the first user device 100 controls an interworking of applications on the basis of the selected attribute having the first priority in the second application of the second user device 200.

Specifically, at step 1419, the first user device 100 controls an application interworking operation according to the priority of a common attribute between the first and second applications. Additionally, at step 1421, the first user device 100 transmits a request for performing an interworking function to the second user device 200 such that an object of the first application can be executed through the second application of the second user device 200.

In one embodiment where a capture function is selected according to an attribute priority of the second application, the first user device 100 captures an object (e.g., a current screen) of the first application and then stores the captured object (e.g., a captured image). Then the first user device 100 transmits a request (including the captured object) for performing an interworking function to the second user device 200 such that the captured object can be executed through the second application of the second user device 200.

In another embodiment where a writing function is selected according to an attribute priority of the second application, the first user device 100 copies an object (e.g., text, image, etc.) of the first application and then stores the copied object. Then the first user device 100 transmits a request (including the copied object) for performing an interworking function to the second user device 200 such that the copied object can be executed through the second application of the second user device 200.

In still another embodiment where a filing function is selected according to an attribute priority of the second application, the first user device 100 creates a file of an object of the first application and then stores the created file of an object. Then the first user device 100 transmits a request (including the object file) for performing an interworking function to the second user device 200 such that the object file can be executed through the second application of the second user device 200.

Namely, the first user device 100 operates such that an object of the main application can be executed through the target application of the second user device 200. At this time, the first user device 100 enables a particular function to be performed using an object of the main application at the target application on the basis of a specific associative attribute having the first priority in the target application.

At step 1423, the second user device 200 outputs a resultant screen in response to a request for performing an interworking function received from the first user device 100. At this time, the second user device 200 operates such that an object of the first application received from the first user device 100 can be displayed through the second application.

In one embodiment, the second user device 200 may further display, through the second application, an object (e.g., a captured image) of the first application received from the first user device 100.

In another embodiment, the second user device 200 may write (i.e., paste) and display, through the second application, an object (e.g., text, image, etc.) of the first application received from the first user device 100.

In still another embodiment, the second user device 200 may add, as an attached file, and display, through the second application, an object (e.g., a file) of the first application received from the first user device 100.

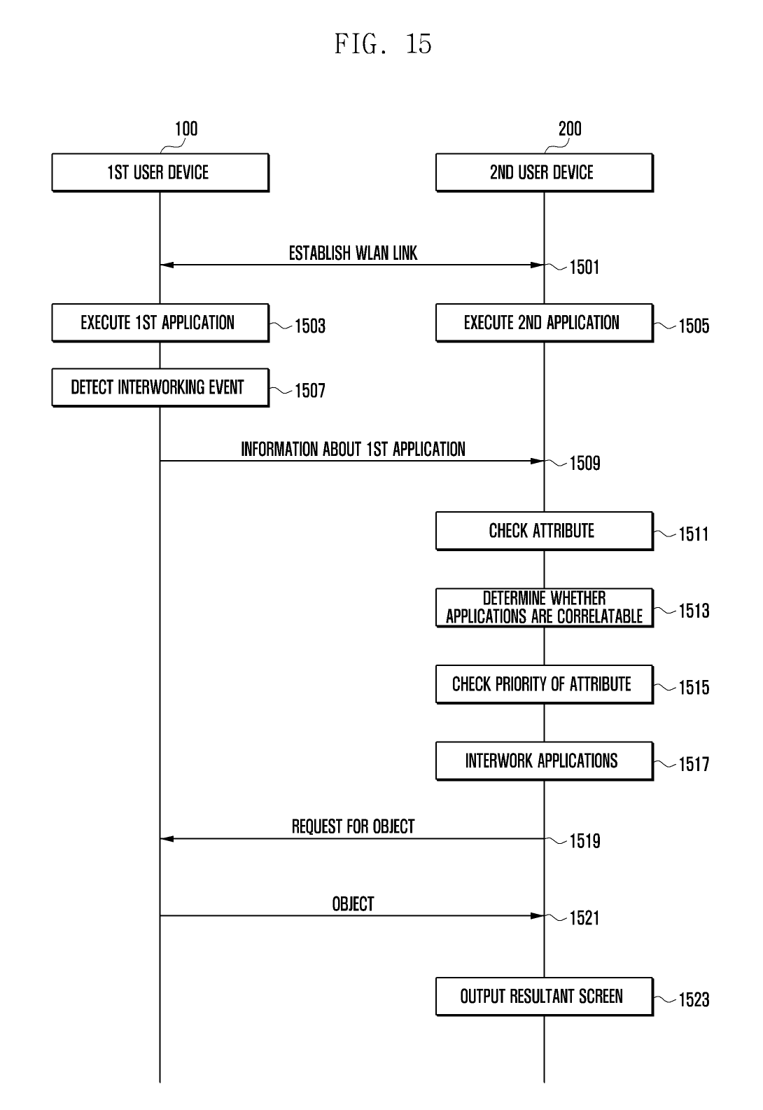

FIG. 15 is a flow diagram illustrating an operating example of interworking applications between user devices in accordance with another embodiment of the present invention.

Referring to FIGS. 13 and 15, at step 1501, the first and second user devices 100 and 200 establish a WLAN link in response to a user's input. In some embodiments, the WLAN link between the user devices 100 and 200 is established in response to a user's input for requesting an external interworking function (or application) of applications. For example, to execute such an external interworking function, the user devices 100 and 200 check the on/off state of the WLAN module, control a turn-on process if the WLAN module is in a turn-off state, and perform a process for establishing the WLAN link between them.

After the WLAN link is established, the first and second user devices 100 and 200 execute respective applications in response to a user's request at steps 1503 and 1505. For example, as discussed above, the first user device 100 executes the first application (A app) and then displays a related object, and also the second user device 200 executes the second application (B app) and then displays a related object. Although FIG. 15 shows an example of executing respective applications after the WLAN link is established, such applications may be executed before the WLAN link is established.

The first user device 100 detects, at step 1507, an interworking event for interworking a currently executed application with another application executed in the second user device 200. For example, a user may take a specific action (i.e., an interworking event input) predefined for an application interworking in the first user device 100 in which the first application is being executed. In embodiments of the present invention, such a specific action for an application interworking includes, but is not limited to, a user gesture to select (e.g., based on a touch or a hovering) a screen displaying a main application (e.g., the first application) and then flick out of the screen, a user gesture (e.g., a hand gesture, a device swing gesture, a device rotation gesture, etc.) to trigger a specific sensor designed for an interworking event input, and the like.

At step 1509, the first user device 100 that detects an interworking event transmits attribute information about the first application, being currently executed, to the second user device 200. As shown in FIG. 15, the first user device 100 sends, to the second user device 200, attribute information about the first application to be interworked with the second application. In other cases, the first user device 100 sends, to the second user device 200, an inherent attribute of the first application to be interworked with the second application.

At step 1511, when attribute information about the first application currently executed in the first user device 100 is received, the second user device 200 checks an attribute (e.g., an inherent attribute) of the first application and an attribute (e.g., an associative attribute) of the second application. Here, the second user device 200 may temporarily store the received attribute information about the first application until an application interworking process is finished.

At step 1513, based on an attribute (e.g., an inherent attribute) of the first application acting as a main application and an attribute (e.g., an associative attribute) of the second application acting as a target application, the second user device 200 determines whether both applications can be correlated.

If both applications can be correlated, at step 1515 the second user device 200 checks an attribute priority on the basis of the attribute information about the second application (i.e., the target application) of the second user device 200. For example, the second user device 200 may select a specific attribute having the first priority from among associative attributes of the second application which are identical to inherent attributes of the first application.

Then, at steps 1517 and 1519, the second user device 200 controls an interworking of applications on the basis of the selected attribute having the first priority in the second application.

Specifically, at step 1517, the second user device 200 identifies an executable function of the main application (e.g., the first application) according to the priority of a common attribute between the first and second applications, and thereby controls an application interworking operation. Additionally, at step 1519, the second user device 200 transmits, to the first user device 100, a request for an object of the first application required for an application interworking. Here, the second user device 200 may request the transmission of an object together with transferring information about an executable function of the first application to the first user device 100. For example, the second user device 200 may request the first user device 100 to transmit an object of the first application such that this object can be executed through the second application in the second user device 200.

At step 1521, when a request for an object of the first application is received from the second user device 200, the first user device 100 transmits the requested object of the first application to the second user device 200. Specifically, when a request for an object is received from the second user device 200, the first user device 100 checks information about an executable function received together with the object request. Then the first user device 100 executes a relevant function by referring to the received information about an executable function, thereby creates an object of the first application, and then transmits the created object to the second user device 200.

In one embodiment where a capture function of the first application is selected according to the received information about an executable function, the first user device 100 captures an object (e.g., a current screen) of the first application and then transmits the captured object (e.g., a captured image) to the second user device 200. In another embodiment where a writing function of the first application is selected according to the received information about an executable function, the first user device 100 copies an object (e.g., text, image, etc.) of the first application and then transmits the copied object to the second user device 200.

Namely, the first user device 100 operates such that an object of the main application can be executed through the target application of the second user device 200. At this time, the second user device 200 may enable a particular function to be performed using an object of the main application at the target application on the basis of a specific associative attribute having the first priority in the target application.

At step 1523, when an object of the first application is received from the first user device 100, the second user device 200 applies the received object of the first application to the second application and then outputs a resultant screen. At this time, the second user device 200 operates such that the object of the first application received from the first user device 100 can be displayed through the second application. In one embodiment, the second user device 200 may further display, through the second application, an object (e.g., a captured image) of the first application received from the first user device 100. In another embodiment, the second user device 200 may write (i.e., paste) and display, through the second application, an object (e.g., text, image, etc.) of the first application received from the first user device 100.

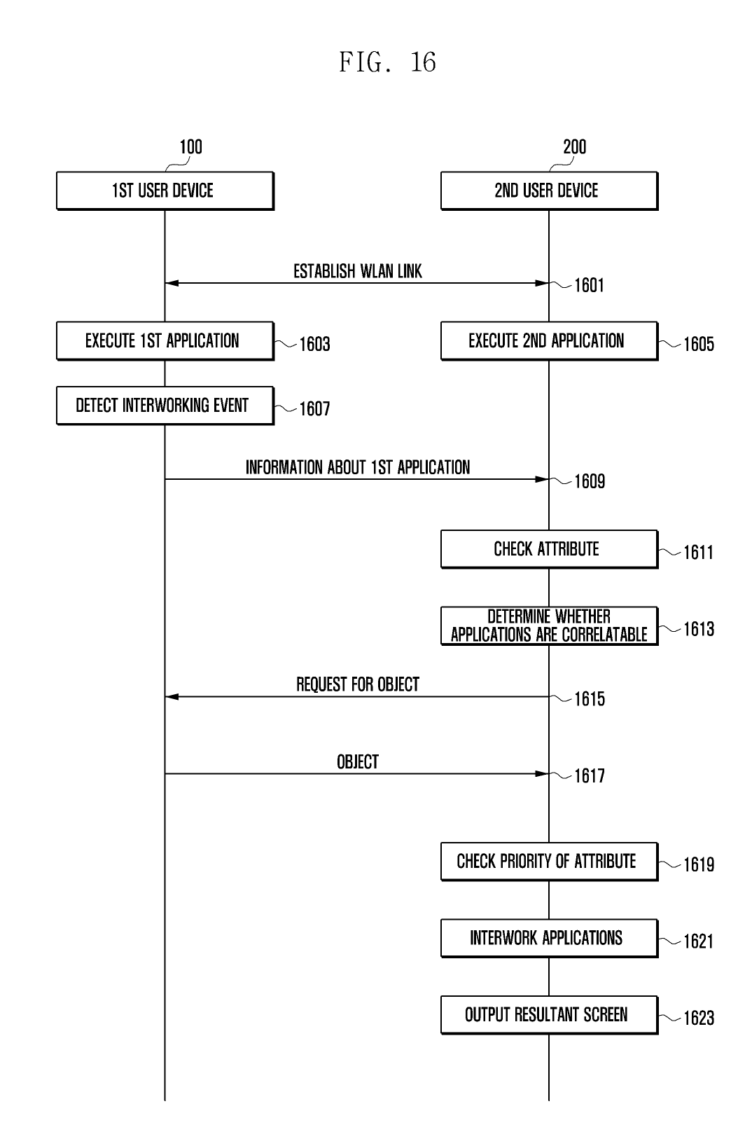

FIG. 16 is a flow diagram illustrating an operating example of interworking applications between user devices in accordance with still another embodiment of the present invention.

Referring to FIGS. 13 and 16, at step 1601, the first and second user devices 100 and 200 establish a WLAN link in response to a user's input.

After the WLAN link is established, the first and second user devices 100 and 200 execute respective applications in response to a user's request at steps 1603 and 1605. For example, as discussed above, the first user device 100 executes the first application (A app) and then displays a related object, and also the second user device 200 executes the second application (B app) and then displays a related object. Although FIG. 16 shows an example of executing respective applications after the WLAN link is established, such applications may be executed before the WLAN link is established.

The first user device 100 detects, at step 1607, an interworking event for interworking the first application, being currently executed, with the second application executed in the second user device 200. For example, a user may take a specific action (i.e., an interworking event input) predefined for an application interworking in the first user device 100 in which the first application is being executed. In embodiments of the present invention, such a specific action for an application interworking may include, but is not limited to, a user gesture to select a screen displaying a main application and then flick out of the screen, a user gesture to trigger a specific sensor designed for an interworking event input, and the like.

At step 1609, the first user device 100 that detects an interworking event transmits attribute information about the first application, being currently executed, to the second user device 200. As in FIG. 16, the first user device 100 sends, to the second user device 200, attribute information about the first application to be interworked with the second application. In any other case, the first user device 100 may send, to the second user device 200, an inherent attribute of the first application to be interworked with the second application.

At step 1611, when attribute information about the first application currently executed in the first user device 100 is received, the second user device 200 checks an attribute (e.g., an inherent attribute) of the first application and an attribute (e.g., an associative attribute) of the second application. Here, when the attribute information about the first application is received from the first user device 100, the second user device 200 determines that the first application of the first user device is a main application. Also, the second user device 200 may temporarily store the received attribute information about the first application until an application interworking process is finished.

At step 1613, based on an attribute (e.g., an inherent attribute) of the first application acting as a main application and an attribute (e.g., an associative attribute) of the second application acting as a target application, the second user device 200 determines whether both applications can be correlated.

If both applications can be correlated, at step 1615, the second user device 200 transmits, to the first user device 100, a request for an object of the first application required for an application interworking. Here, the second user device 200 may request the transmission of an object together with transferring attribute information (e.g., an associative attribute) about the second application to be interworked with the first application. For example, the second user device 200 may request the first user device 100 to transmit an object of the first application such that this object can be executed through the second application in the second user device 200.

At step 1617, when a request for an object of the first application is received from the second user device 200, the first user device 100 transmits the requested object of the first application to the second user device 200. Specifically, when a request for an object is received from the second user device 200, the first user device 100 checks attribute information (e.g., an associative attribute) about the second application. Then the first user device 100 executes a correlatable function by referring to the attribute information about the second application, thereby creates an object of the first application, and then transmits the created object to the second user device 200.

In one embodiment where a capture function and a writing function are selected as correlatable functions according to the attribute information about the second application, the first user device 100 may capture and copy objects of the first application. Then the first user device 100 may transmit the captured object and the copied object to the second user device 200.

At step 1619, when an object of the first application is received from the first user device 100, the second user device 200 checks an attribute priority on the basis of the attribute information about the second application of the second user device 200. For example, the second user device 200 may select a specific attribute having the first priority from among associative attributes of the second application which are identical to inherent attributes of the first application.

Then, at step 1621, the second user device 200 controls an interworking of applications on the basis of the selected attribute having the first priority in the second application. Specifically, based on the priority of a common attribute between the first and second applications, the second user device 200 operates such that the object received from the first user device 100 can be executed through the second application. In an embodiment, the second user device 200 may select, based on an attribute priority, one of the captured object and the copied object of the first application received from the first user device 100, and then control the selected object to be executed through the second application. Namely, the second user device 200 may enable a particular function to be performed using an object of the first application at the second application on the basis of a specific associative attribute having the first priority in the second application.

At step 1623, the second user device 200 outputs a resultant screen caused by an interworking operation using an object of the first application at the second application. At this time, the second user device 200 operates such that the object of the first application received from the first user device 100 can be displayed through the second application.

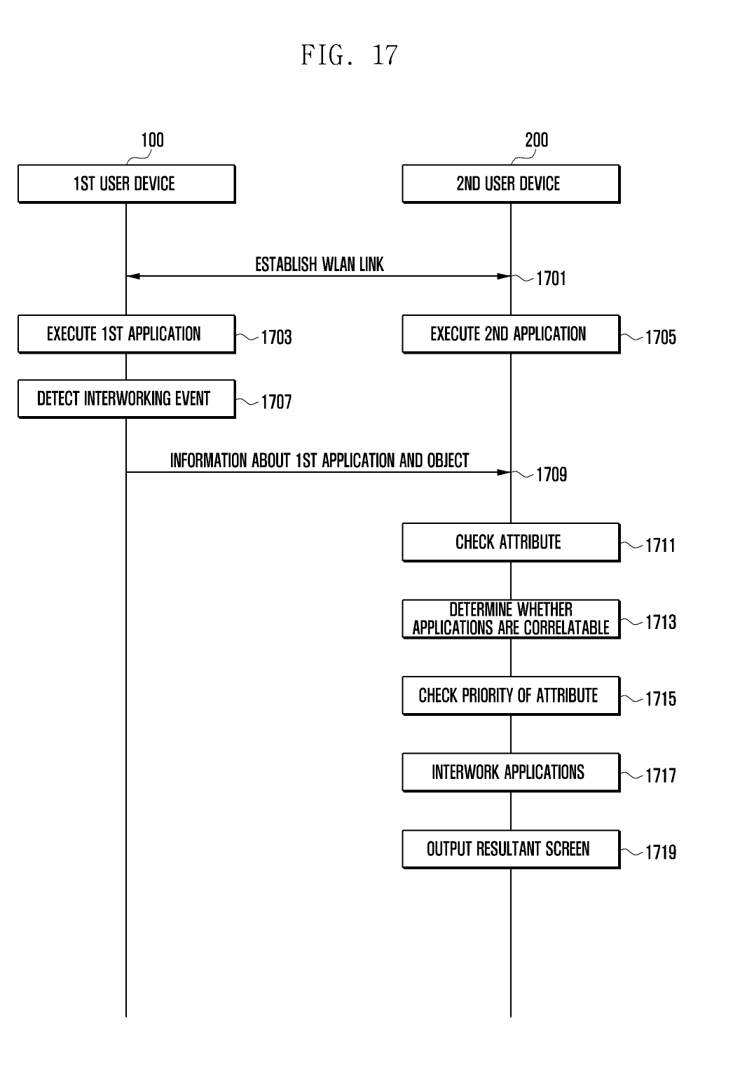

FIG. 17 is a flow diagram illustrating an operating example of interworking applications between user devices in accordance with yet embodiment of the present invention.

Referring to FIGS. 13 and 17, at step 1701, the first and second user devices 100 and 200 establish a WLAN link in response to a user's input.

After the WLAN link is established, the first and second user devices 100 and 200 execute respective applications in response to a user's request at steps 1703 and 1705. For example, as discussed above, the first user device 100 executes the first application (A app) and then displays a related object, and also the second user device 200 executes the second application (B app) and then displays a related object. Although FIG. 17 shows an example of executing respective applications after the WLAN link is established, such applications may be executed before the WLAN link is established.

The first user device 100 detects, at step 1707, an interworking event for interworking the first application, being currently executed, with the second application executed in the second user device 200. For example, a user may take a specific action (i.e., an interworking event input) predefined for an application interworking in the first user device 100 in which the first application is being executed. In embodiments of the present invention, such a specific action for an application interworking may include, but is not limited to, a user gesture to a screen displaying a main application and then flick out of the screen, a user gesture to trigger a specific sensor designed for an interworking event input, and the like.

At step 1709, the first user device 100 that detects an interworking event transmits attribute information about the first application, together with a related object, to the second user device 200. As shown in FIG. 17, the first user device 100 sends, to the second user device 200, attribute information about the first application to be interworked with the second application. In any other case, the first user device 100 may send, to the second user device 200, an inherent attribute of the first application to be interworked with the second application.

Additionally, in an embodiment shown in FIG. 17, the first user device 100 executes a correlatable function based on attribute information about the second application, thereby creates at least one object, and then transmits the created object to the second user device 200. In one embodiment where a capture function and a writing function are selected as correlatable functions according to the attribute information (e.g., an inherent attribute) about the first application, the first user device 100 may capture and copy objects of the first application. Then the first user device 100 may transmit the captured object and the copied object to the second user device 200.

At step 1711, when attribute information about the first application currently executed in the first user device 100 is received together with a related object from the first user device 100, the second user device 200 checks an attribute (e.g., an inherent attribute) of the first application and an attribute (e.g., an associative attribute) of the second application. Here, when the attribute information about the first application and a related object are received together from the first user device 100, the second user device 200 determines that the first application of the first user device is a main application. Also, the second user device 200 may temporarily store the received attribute information about the first application until an application interworking process is finished.

At step 1713, based on an attribute (e.g., an inherent attribute) of the first application acting as a main application and an attribute (e.g., an associative attribute) of the second application acting as a target application, the second user device 200 determines whether both applications can be correlated.

If both applications can be correlated, at step 1715 the second user device 200 checks an attribute priority on the basis of the attribute information about the second application of the second user device 200. For example, the second user device 200 may select specific attribute having the first priority from among associative attributes of the second application which are identical to inherent attributes of the first application.

Then, at step 1717, the second user device 200 controls an interworking of applications on the basis of the selected attribute having the first priority in the second application. Specifically, based on the priority of a common attribute between the first and second applications, the second user device 200 operates such that the object received from the first user device 100 can be executed through the second application. In an embodiment, the second user device 200 selects, based on an attribute priority, one of the captured object and the copied object of the first application received from the first user device 100, and then controls the selected object to be executed through the second application. Namely, the second user device 200 may enable a particular function to be performed using an object of the first application at the second application on the basis of a specific associative attribute having the first priority in the second application.

At step 1719, the second user device 200 outputs a resultant screen caused by an interworking operation using an object of the first application at the second application. At this time, the second user device 200 operates such that the object of the first application received from the first user device 100 can be displayed through the second application.

As fully discussed hereinbefore, various embodiments of the present invention may separately assign an attribute to each application and further define the priority of such attributes. Additionally, a main application and a target application can be distinguished from each other in a multi-screen environment. Also, by referring to both an inherent attribute of the main application and an associative attribute of the target application, an interworking operation can be performed on the basis of a particular function selected by a specific attribute having the first priority from among correlatable attributes.

According to embodiments of the present invention, single or plural functions (e.g., a capture function, a file attaching function, a copy-and-paste function, an insertion-after-capture function, a capture-and-attaching function, etc.) may be performed automatically in view of attributes of applications, and a result thereof may be visually offered through a target application. Further, such a result may be offered through a window of the target application in a multi-screen environment or alternatively through a full screen with a multi-screen removed.

The above-discussed method is described herein with reference to flowchart illustrations of user interfaces, methods, and computer program products according to embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

While the present invention has been particularly shown and described with reference to embodiments thereof, it will be understood by those skilled in the art that various changes in form and details may be made therein without departing from the spirit and scope of the present invention as defined by the appended claims and their equivalents.

What is claimed is:

1. A method for interworking applications in a user device, the method comprising:
displaying a plurality of applications;
analyzing an attribute of each application in response to a user input for interworking the applications; and
interworking the applications on the basis of the attribute of each application.

2. The method of claim 1, wherein the user input includes an interworking event that happens by a specific user action predefined for interworking a first application and a second application.

3. The method of claim 2, wherein the interworking event is one of a plurality of interactions that are entered by a user, including a touch gesture, a hovering gesture, and a hand gesture.

4. The method of claim 3, wherein analyzing the attribute of each application includes:
determining that an application offering an object in response to the user input is the first application; and
determining that an application receiving the object of the first application in response to the user input is the second application.

5. The method of claim 3, wherein analyzing the attribute of each application includes:
analyzing an inherent attribute of the first application; and
analyzing an associative attribute of the second application.

6. The method of claim 2, further comprising:
based on the attribute of each application, determining whether the applications can be interworked with each other.

7. The method of claim 6, wherein determining whether the applications can be interworked with each other includes finding a common or identical attribute by comparing an inherent attribute of the first application with an associative attribute of the second application.

8. The method of claim 2, wherein interworking the applications includes executing an application interworking operation according to an attribute priority of the applications.

9. The method of claim 8, wherein executing the application interworking operation includes determining a specific attribute having the first priority from among identical attributes between inherent attributes of the first application and associative attributes of the second application.

10. The method of claim 9, wherein the specific attribute having the first priority is determined from among the associative attributes which are identical to the inherent attributes.

11. The method of claim 6, wherein determining whether the applications can be interworked with each other is performed depending on whether there is an identical attribute between inherent attributes of the first application and associative attributes of the second application.

12. The method of claim 2, further comprising:
outputting a result of the interworking of the applications.

13. The method of claim 12, wherein outputting the result includes controlling an object of the first application to operate through the second application.

14. The method of claim 13, wherein outputting the result includes displaying an operating result of the object of the first application through a window of the second application from among windows that form a multi-screen in the user device.

15. The method of claim 14, wherein outputting the result includes controlling the object of the first application to operate through the second application after removing the multi-screen.

16. The method of claim 14, wherein outputting the result includes displaying the operating result on a full screen converted from the window of the second application.

17. The method of claim 12, wherein outputting the result includes displaying the interworking result through a display unit of an external user device in which the second application is executed.

18. The method of claim 1, wherein displaying the plurality of applications includes displaying respectively the applications through a first user device and a second user device.

19. The method of claim 1, wherein interworking the applications includes executing a single function or plural functions by using a first application on the basis of the attribute of each application, and outputting an executing result through a second application.

20. An application interworking method comprising:
detecting an interworking event for an interworking between applications;
distinguishing a first application and a second application from the applications;
determining an attribute of the first application and an attribute of the second application;
checking a priority of a specific attribute which is correlatable between the first and second applications, from among the attributes of the first and second applications;
interworking the first and second applications on the basis of the priority of the specific attribute; and
outputting a result of the interworking.

21. The method of claim 20, wherein determining the attribute includes determining a correlation of the attributes between the applications by referring to inherent attributes of the first application and associative attributes of the second application.

22. The method of claim 21, wherein checking the priority of the specific attribute is performed within the associative attributes which are identical to the inherent attributes.

23. The method of claim 21, further comprising:
executing the first application through a first window which is one of windows that form a multi-screen in a user device; and
executing the second application through a second window which is another window of the multi-screen.

24. The method of claim 23, wherein outputting the result includes removing the multi-screen, executing the second application on a full screen, and outputting through the full screen a result of executing a particular function by using an object of the first application.

25. The method of claim 23, wherein the outputting the result includes outputting a result of executing a particular function by using an object of the first application, through the second window with the multi-screen maintained.

26. The method of claim 20, further comprising:
executing the first application in a first user device; and
executing the second application in a second user device.

27. The method of claim 26, wherein outputting the result includes:
at the first user device, offering an object of the first application to the second user device; and
at the second user device, outputting through the second application a result of executing a particular function by using the object of the first application.

28. A user device comprising:
a touch screen configured to display an execution screen of each of applications and to receive an interworking event for an interworking between the applications; and
a control unit configured to control the applications to be interworked with each other on the basis of an attribute defined in each application.

29. The user device of claim 28, wherein the control unit is further configured to check a correlation between the applications on the basis of the attribute defined in each application, and to control the interworking between the applications according to an attribute priority.

30. The user device of claim 29, wherein the control unit includes:
an attribute processing module configured to determine whether each application has the ability to be interworked, using an attribute of each application in response to an interworking event;
an interworking processing module configured to identify priorities about attributes of the applications and, based on the attributes, to interwork the applications; and
an object display module configured to process a display of objects caused by the interworking of applications.

31. The user device of claim 29, wherein the control unit includes:
a window display module configured to divide a screen of a user device into a plurality of windows in response to the execution of a multi-screen, and further to separately display objects of the applications through the windows.

32. The user device of claim 29, wherein the control unit is further configured to control a display of a multi-screen, to respectively display the applications through divided windows of the multi-screen, to analyze the attribute of a specific application in response to the interworking event, and to perform a particular function by the interworking between the applications on the basis of an attribute priority in each application.

33. The user device of claim 29, wherein the control unit is further configured to distinguish a first application and a second application from the applications in response to the interworking event in a multi-screen, and to determine a correlation of the attributes between the applications by referring to inherent attributes of the first application and associative attributes of the second application.

34. The user device of claim 29, further comprising:
a memory unit configured to store the attributes of the applications, inherent attributes when the applications act as a first application, associative attributes when the applications act as a second application, and priorities of the associative attributes.

35. The user device of claim 29, wherein the control unit is further configured to control a particular function using an object of a first application to be performed through a second application of an external user device.

36. A computer-readable medium having recorded thereon a program configured to define control commands for displaying an object of an application, for detecting a user input for interworking the applications, for interworking the applications on the basis of a selected attribute of the applications, and for displaying an object caused by the interworking of the applications.
